(19) United States
(12) Patent Application Publication
(10) Pub. No.: US 2003/0025599 A1
(43) Pub. Date: Feb. 6, 2003

(54) Method and apparatus for collecting, sending, archiving and retrieving motion video and still images and notification of detected events

(76) Inventor: David A. Monroe, San Antonio, TX (US)

Correspondence Address: Jackson, Walker L.L.P., 112 E. Pecan, suite 2100, SanAntonio, TX, 78205, US

(21) Appl. No.: 09/853,274

(22) Filed: May 11, 2001

(51) Int. Cl. G08B 1/00

(52) U.S. Cl. 340/531; 340/541; 340/540; 340/519; 340/521; 709/200; 709/207

(57) ABSTRACT

A method for identifying the occurrence of an event at a remote location, prioritizing the event, and then, based on the priority, forwarding the event to selected stations on a network incorporates a scheme for tagging the event with the location, type and priority of event at the point where a sensor picks up the event. Event data is then forwarded only to selected stations on the network as required by a priority hierarchy. This permits a large amount of data to be collected at the site of a sensor while minimizing transmission of the data to an as-needed basis, reducing the overall bandwidth requirements of the system. In one aspect, legacy device signals, appliance signals and video and still image data generated at a remote location includes is collected on a preselected basis for defining and transmitting an original condition to the remote location. Subsequent data is compared to the data representing the original condition. The transmitted data may be tagged with unique identifying components. The transmitted data is stored for archival, search and retrieval. A notification signal may also be generated and based on prioritization may be forwarded to selected recipients. Notification is also visually indicated on map and other graphic display monitors.

### BACKGROUND OF INVENTION:

1. Field of Invention

The subject invention is generally related to the collection, sending, archiving and retrieving of event data, including video and image data, and is specifically directed to a method for detecting, archiving, and researching said events and for notification of such events on a near real-time basis.

2. Description of the Prior Art

Security of public facilities such as schools, banks, airports, arenas and the like has been a topic of increasing concern in recent years. Over the past few years, a number of violent incidents including bombings, shootings, arson, and hostage situations have occurred. In addition, agencies responsible for public security in these facilities must cope with more commonplace crimes, such as drug dealing, vandalism, theft and the like.

Such facilities frequently employ monitoring and surveillance systems to enhance security. This has been common practice for a number of years. Such systems generally have a centralized monitoring console, usually attended by a guard or dispatcher. A variety of sensors, cameras and the like are located throughout the facility. These detectors and sensors, or devices, are utilized to collect information at remote locations and initiate a local alarm, store the information for later retrieval or forward the information to a remote location for storage and/or near real time review and/or later search and retrieval. Almost all of such devices can be used in some form of managed network where one or more devices may be used in combination to provide a surveillance scheme over an area to be monitored. In prior art systems, the signal generated by each type of device was used locally, or if part of a network, was sent over a dedicated network to a remote collection point for that type of device. For example, prior art alarm systems can be monitored locally or remotely by a monitor console. Video surveillance systems are typically monitored locally or recorded by local video tape recorders.

These prior-art monitoring devices often use technologies that not ‘intelligent’ in the modem sense; they merely provide an ‘ON/OFF’ indication to the centralized monitoring system. The appliances also are not ‘networked’ in the modem sense; they are generally hard-wired to the centralized monitoring system via a ‘current loop’ or similar arrangement, and do not provide situational data other than their ON/OFF status.

Video surveillance systems in common use today are particularly dated—they are generally of low quality, using analog signals conveyed over coaxial or, occasionally, twisted-pair cabling to the centralized local monitoring facility. Such visual information is generally archived on magnetic tape using analog video recorders. Further, such systems generally do not have the ability to ‘share’ the captured video, and such video is generally viewable only on the system's control console.

Prior art systems have typically employed analog cameras, using composite video at frame rates up to the standard 30 frames/second. Many such systems have been monochrome systems, which are less costly and provide marginally better resolution with slightly greater sensitivity under poor lighting conditions than current analog color systems. Traditional video cameras have used CCD or CMOS area sensors to capture the desired image. The resolution of such cameras is generally limited to the standard CCTV 300-350 lines of resolution, and the standard 480 active scan lines.

Such cameras are deployed around the area to be observed, and are connected to a centralized monitoring/recording system via coaxial cable or, less often, twisted-pair (UTP) wiring with special analog modems. The signals conveyed over such wiring are almost universally analog, composite video. Baseband video signals are generally employed, although some such systems modulate the video signals on to an RF carrier, using either AM or FM techniques. In each case, the video is subject to degradation due to the usual causes—crosstalk in the wiring plant, AC ground noise, interfering carriers, and so on.

More recently, security cameras have employed video compression technology, enabling the individual cameras to be connected to the centralized system via telephone circuits. Due to the bandwidth constraints imposed by the public-switched telephone system, such systems are typically limited to low-resolution images, or low frame rates, or both. Other more modem cameras have been designed for “web cam” use on the Internet. These cameras use digital techniques for transmission, however their use for security surveillance is limited by low resolution and by slower refresh rates. These cameras are also designed for used by direct connection to PC's, such as by Printer, USB or Firewire Ports. Thus the installation cost and effectivity is limited with the unwieldy restriction of having to have a PC at each camera.

Prior-art surveillance systems are oriented towards delivering a captured video signal to a centralized monitoring facility or console. In the case of analog composite video signals, these signals were transported as analog signals over coaxial cable or twisted-pair wiring, to the monitoring facility. In other systems, the video signals were compressed down to low bit rates, suitable for transmission over the public-switched telephone network or the Internet.

Each of these prior-art systems suffers functional disadvantages. The composite video/coaxial cable approach provides full-motion video but can only convey it to a local monitoring facility. The low-bit rate approach can deliver the video signal to a remote monitoring facility, but only with severely degraded resolution and frame rate. Neither approach has been designed to provide access to any available video source from several monitoring stations.

Another commonplace example is the still-image compression commonly used in digital cameras. These compression techniques may require several seconds to compress a captured image, but once done the image has been reduced to a manageably small size, suitable for storage on inexpensive digital media (e.g., floppy disk) or for convenient transmission over an inexpensive network connection (e.g. via the internet over a 28.8 kbit/sec modem).

Prior-art surveillance systems have been oriented towards centralized monitoring of the various cameras. While useful, this approach lacks the functional flexibility possible with more modem networking technologies.

Video monitoring and surveillance of locations or areas for security, safety monitoring, asset protection, process control, and other such applications by use of closed circuit television and similar systems have been in widespread use for many years. The cost of these systems has come down significantly in recent years as the camera and monitor components have steadily dropped in cost while increasing in quality. As a result, these systems have proliferated in their application and are proving extremely useful for both commercial and residential applications.

These “closed circuit television” systems typically consist of a monochrome or color television camera, a coaxial cable, and a corresponding monochrome or color video monitor, optional VCR recording devices, and power sources for the cameras and monitors. The interconnection of the camera and monitor is typically accomplished by the use of coaxial cable, which is capable of carrying the 2 to 10 megahertz bandwidths of baseband closed circuit television systems. There are several limitations to coaxial cable supported systems. First, the cable attenuates by the signal in proportion to the distance traveled. Long distance video transmission on coaxial cable requires expensive transmission techniques. Second, both the cable, per se, and the installation is expensive. Both of these limitations limit practical use of coaxial closed circuit systems to installations requiring less than a few thousand feet of cable. Third, when the cable cannot be concealed is not only unsightly, but is also subject to tampering and vandalism.

Other hardwired systems have been used, such as fiber optic cable and the like, but have not been widely accepted primarily due to the higher costs associated with such systems over coaxial cable. Coaxial cable, with all of its limitations, remains the system of choice to the present day. Also available are techniques using less expensive and common twisted pair cable such as that commonly used for distribution of audio signals such as in telephone or office intercom applications. This cable is often referred to as UTP (twisted pair) or STP (shielded twisted pair) cable. Both analog and digital configurations are available. Both analog and digital techniques have been implemented. This general style of twisted pair cable but in a more precise format is also widely used in Local Area Networks, or LAN's, such as the 10Base-T Ethernet system, 100 Base-T, 1000 Base-T and later systems. Newer types of twisted pair cable have been developed that have lower capacitance and more consistent impedance than the early telephone wire. These newer types of cable, such as “Category 5 ” wire, are better suited for higher bandwidth signal transmission and are acceptable for closed circuit video applications with suitable special digital interfaces. By way of example, typical audio voice signals are approximately 3 kilohertz in bandwidth, whereas typical video television signals are 3 megahertz in bandwidth or more. Even with the increased bandwidth capability of this twisted pair cable, the video signals at base band (uncompressed) can typically be distributed directly over twisted pair cable only a few hundred feet. In order to distribute video over greater distances, video modems (modulator/demodulators) are inserted between the camera and the twisted pair wiring and again between the twisted pair wiring and the monitor. Twisted pair cable is lower in cost than coaxial cable and is easier to install. For the longest distances for distribution of video, the video signals are digitally compressed for transmission and decompressed at the receiving end.

Wireless systems utilizing RF energy are also available. Such systems usually consist of a low power UHF transmitter and antenna system compatible with standard television monitors or receivers tuned to unused UHF channels. The FCC allows use of this type of system without a license for very low power levels in the range of tens of milliwatts. This type of system provides an economical link but does not provide transmission over significant distances due to the power constraints placed on the system. It is also highly susceptible to interference due to the low power levels and share frequency assignments. The advantage of this system over hardwired systems is primarily the ease of installation. However, the cost is usually much higher per unit, the number of channels is limited and system performance can be greatly affected by building geometry or nearby electrical interference. Further, the video is not as secure as hardwired systems. The video may be picked up by anyone having access to the channel while in range of the transmitter and is thus, easily detected and/or jammed.

Because of the inherent limitations in the various closed circuit television systems now available, other media have been employed to perform security monitoring over wider areas. This is done with the use of CODECs (compressors/decompressors) used to reduce the bandwidth. Examples include sending compressed video over standard voice bandwidth telephone circuits, more sophisticated digital telephonic circuits such as frame relay or ISDN circuits and the like. While commonly available and relatively low in cost, each of these systems is of narrow bandwidth and incapable of carrying “raw” video data such as that produced by a full motion video camera, using rudimentary compression schemes to reduce the amount of data transmitted. As previously discussed, full motion video is typically 2 to 10 megahertz in bandwidth while typical low cost voice data circuits are 3 kilohertz in bandwidth.

There are known techniques for facilitating “full motion” video over common telecommunication circuits. The video teleconferencing (VTC) standards currently in use are: Narrow Band VTC (H.320); Low Bitrate (H.324); ISO-Ethernet (H.322); Ethernet VTC (H.323); ATM VTC (H.321); High Resolution ATM VTC (H.310). Each of these standards has certain advantages and disadvantages depending upon the volume of data, required resolution and costs targets for the system. These are commonly used for video teleconferencing and are being performed at typical rates of 128K, 256K, 384K or 1.544M bit for industrial/commercial use. Internet teleconferencing traditionally is at much lower rates and at a correspondingly lower quality. Internet VTC may be accomplished at 33.6 KBPS over dial-up modems, for example. Video teleconferencing is based on video compression, such as the techniques set forth by CCITT/ISO standards, Internet standards, and Proprietary standards or by MPEG standards. Other, sometimes proprietary, schemes using motion wavelet or motion JPEG compression techniques and the like are also in existence. There are a number of video teleconferencing and video telephone products available for transmitting “full motion” (near real-time) video over these circuits such as, by way of example, systems available from AT&T and Panasonic. While such devices are useful for their intended purpose, they typically are limited in the amount of data, which may be accumulated and/or transmitted because they do not rely on or have limited compression. There are also devices that transmit “live” or in near real-time over the Internet, such as QuickCam2 from Connectix, CU-See-Me and Intel products utilizing the parallel printer port, USB port, Firewire port, ISA, PCI card, or PCMCIA card on a laptop computer. Many of these are personal communications systems do not have the resolution, the refresh rate required or the security required to provide for good surveillance systems. NetMeeting from Microsoft and Proshare software packages from Intel also provide low quality personal image distribution over the Internet.

All of the current low cost network products have the ability to transmit motion or “live” video. However, such products are limited or difficult, if not impossible, to use for security applications because the resolution and refresh rate (frame rate) of the compressed motion video is necessarily low because of limited resolution of the original sample and the applications of significant levels of video compression to allow use of the low bandwidth circuits. The low resolution of these images will not allow positive identification of persons at any suitable distance from the camera for example. The low resolution would not allow the reading of an automobile tag in another example.

As these devices, particularly digital video cameras and encoders, come in more widespread use within a system, the amount of bandwidth required to transmit continuous, “live” images from an array of cameras is staggering. This is even a greater problem when retrofitting current facilities where it is desired to use current wiring or to incorporate wireless networking techniques. Even where the conduits are of sufficient capacity to handle the data load, storage and retrieval becomes an enormous task. It is, therefore, desirable to provide a system capable of maximizing the information available via a security system while at the same time minimizing transmission and storage requirements.

In many security applications it is desirable to monitor an area or a situation with high resolution from a monitor located many miles from the area to be surveyed. As stated, none of the prior art systems readily available accommodates this. Wide band common carriers such as are used in the broadcast of high quality television signals could be used, but the cost of these long distance microwave, fiber or satellite circuits is prohibitive.

None of the prior art systems permit structured and controlled notification based on the identification of events as they occur. Even those that do permit some limited notification, for example, alarm systems sending a telephone signal to a monitoring station, do not provide detailed event information. Such systems are more global in configuration, simply sending a notification that an event has occurred at a monitored facility.

### SUMMARY OF INVENTION

The system of the subject invention is a sophisticated situational awareness system that is network based. The elements of the system include digital surveillance information collection, information processing system, automated dispatch, logging, remote access and logging. The system consists of intelligent sensors, servers, and monitor stations all interconnected by wired and wireless network connections over potentially wide geographic areas. The system includes a variety of system appliances such as surveillance cameras, sensors and detectors and accommodates legacy equipment, as well. Traditional information is collected, analyzed, archived and distributed. This includes raw sensor data such as images, video, audio, temperature, contact closure and the like. This information has been traditionally collected by legacy closed circuit television systems and alarm systems. The system digitizes all of this information and distributes it to the monitor stations and to a notification processor. The processor analyzes the information and dispatches security and/or administrative personnel based upon events such as motion detection or a triggered sensor in a particular area in a particular time window when the system is “armed”. Administrative and maintenance triggers may also be generated.

The subject invention is directed to a method for identifying the occurrence of an event at a remote location, qualifying the event as to its type, prioritizing the event, and then, based on the qualification and the priority, forwarding the event to selected stations on a network. Basically, the location, type and priority of event are “tagged” at the point where a sensor picks up the event and event data is then forwarded only to selected stations on the network as required by a qualification system and a priority hierarchy. This permits a large amount of data to be collected at the site of a sensor while minimizing transmission of the data to an “as-needed” basis, reducing the overall bandwidth requirements of the system and focusing the notification to the specific individuals or organizations that need to be involved. As an example, while periodic data may be gathered at a sensor, only data indicating a change in condition will be transmitted to various monitoring stations. In addition, monitoring stations are selected based on pre-established hierarchy, typically managed by a system server.

On aspect of the invention provides for continuous or selective monitoring of a scene with live video to detect any change in the scene while minimizing the amount of data that has to be transmitted from the camera to the monitoring station and while at the same time maximizing storage, search and retrieval capabilities. Another aspect of the invention is a method of event notification whereby detected events from sensors, sensor appliances, video appliances, legacy security alarm systems and the like are processed and a comprehensive and flexible method of notifying individuals and organizations is provided using a plurality of methods, such as dial up telephones, cellular and wireless telephones, pagers, e-mail to computers, digital pagers, cellular phones, wireless PDA's, and other wireless devices, and direct network notification to workstations based on I/P addressing such as to workstations, digital pagers, digital cellular phones, wireless PDA's and other network and wireless devices. The preferred embodiments of the invention are directed to a method for collecting, selecting and transmitting selected scene data available at a camera to a remote location includes collecting the image data on a preselected basis at the camera and defining and transmitting an original scene to the remote location. Subsequent data of the scene is compared to the data representing the scene in its original state. Only subsequent data representing a change is the original scene is transmitted. Each transmitted data scene may be tagged with unique identifying data. The transmitted data is stored for archival, search and retrieval. The selection scheme of the invention also permits notification of the detected events to be sent via a network to selected monitoring stations.

The system of the subject invention has a wide range of versatility, beginning with normal default modes that make the system fully operational and including programmable modes for customizing the system to the specific application. Programmable modes include: (1) Video motion detection with parameters configurable by a remote user; (2) Video motion detection configurable by a remote user to select areas of interest or disinterest in the video scene; and (3) Video motion detection used to trigger generation, storage, or transmission of compressed digital images.

The system of the subject invention includes the capability of associating motion data from a video image with compressed digital images, using an improved method for transmitting a succession of compressed digital still images from a live source to an image database server. A network-based server is provided for archiving and retrieving compressed digital image files from a plurality of live sources through an efficient and rapid means for uniquely identifying compressed digital image files sent to a system server. An improved means for storing compressed image files on a tape storage system is also disclosed.

The graphical user interface is user-friendly and provides convenient and efficient browsing through a video image file database, and for efficiently selecting files there from.

The subject invention is directed to several distinct aspects of image data collection and retrieval, namely: (1) motion and object detection, (2) legacy sensor and alarm data importation, (3) event filtering to qualify alarm and supervisory events (4) notification, (5) data archiving and retrieval, and (6) user interface technology.

The invention recognizes the need for the camera or video encoder appliance to capture, compress and transmit the image on-site. Without proper compression the amount of data to be transmitted soon overwhelms even the largest capacity systems. In the subject invention, while continuous data is captured, it is recognized that only changes in data need to be transmitted. Specifically, only when a scene changes from the previous captured image is it required that the image be transmitted to a remote monitoring station, and more importantly, stored on the archive database. Thus, while images may be taken at close intervals or even as streaming video, if there is not any discernible change in the image data from the original image and the subsequent images, the data is not required to be transmitted. Further, the level of change is monitored at the camera and only specific criteria trigger a transmission. For example, the rotation of a ceiling fan may be ignored by masking techniques, whereas the opening of a door would trigger an immediate transmission. The camera system calculates the difference between two images and produces a “difference” map or scene. The difference map is then transmitted, or compressed and transmitted. In the preferred embodiment, a comparison histogram of the differences is also generated readily determining the degree of change. This quantifies the amount of motion or change in an image from frame-to-frame and will assist in determining the appropriate response to the change.

The use of thresholds for activation eliminates inadvertent alarm conditions. As an example, if a dragonfly enters the scene you may not wish to trigger the alarm. By setting a video threshold, smaller levels of motion could be ignored, while larger levels of motion could be determined to be an alarm event. It is recognized that a dragonfly close to a camera lens could look like a B-52 attack to the camera. Two or more cameras can be correlated to avoid this problem. For example if two cameras were monitoring the same scene from different positions, motion above a set threshold on both cameras can be required before an alarm event is determined. A dragonfly could not be close to both cameras simultaneously; thus a dragonfly would not generate a trigger event.

In order to further maximize the efficiency of data review and analysis the system of the preferred embodiment only analyzes the luminance (gray-scale) differences between captured frames and the scene may be decimated to look only at the differing pixels between images rather than all pixels of the image. The recognition of a detected change also lends itself to generation and transmission of a notification signal for alerting response personnel at the time the motion is detected. This permits rapid response to a zone where unauthorized activity is taking place, on a real-time basis.

The recognition of a detected object left in a specific location or taken from a specific location also lends itself to generation and transmission of a notification signal for alerting response personnel at the time the object is detected appearing or disappearing.

Regions of images may be defined as well so that the system can ignore anticipated or normal motions such as a rotating fan or the like. This is done be masking defined portions of the scene. This can be pre-programmed such as by setting up masking at an remote monitor. In this manner, the camera or encoder appliance only transmits images or video that has a pre-indication of a change in the previous scene, greatly reducing the amount of data to be transmitted over the chosen conduit.

Masks can also be built automatically. The system may be “trained” to build a motion mask during a controlled period of time, then any motion detected in a region over a given threshold would set the mask. For example, the ceiling fan can be turned on, the training armed, than any areas of the scene where the motion of the ceiling fan was detected would set bits in the mask. Later, when the system is armed normally, the bits in this mask would be used to block motion alarming because of motion caused by the fan blades. That motion in that area of the picture would be ignored. Thus a certain threshold of activity over and above a normal activity (of the ceiling fan) is required to trigger a motion detection event.

The automatic mask generation process may be enhanced by enlarging the mask area slightly such that there is a guard zone or safe zone created around the known motion to protect against false triggers from such items as the fan blades going slightly out of balance, a breeze blowing the fan blades and the fan to another position, the sensor voltages varying slightly causing drift and focus issues, and the like. During mask generation an overlay of the image representing the mask area can be built for operator review and modification. The masked area can be highlighted as an overlay on top of the image, for example.

A mask may also be used on the regions to activate, deactivate, or weight the region in determining an alarm condition. For example, a window on a locked door may show motion on the outside of a door, and it could be desired that motion seen through a window is not defined as an alarm condition. The mask can be used to block triggering from motion as seen through the window. This is accomplished by picking the region or regions that mask the window and deactivating it for a trigger event.

A graphic drawing tool can be used to draw around areas in a scene that are to be considered or not considered for trigger events. This can then either generate a custom masking region, or can select a set of predefined regions that are used to create “the best” mask fitting the scenario. An example of excluding motion detection by masking is a window in an outside door that is to be masked such that it does not detect motion. An example of including motion detection by masking would be aiming a camera on paintings in a museum at an oblique angle, and setting masking such that any motion in the area of the painting would generate a motion trigger while motion outside of that region would not generate a trigger

The intelligent cameras can support several types of event detection at one time. For example, a camera can be detecting any motion at all would generate a motion event to control storing to the archival server, a process we call “activity gated storage”. That same camera can simultaneously have a mask set such that the motion in the area of a painting indicating either attempted vandalism or theft of the painting would trigger an alarm event for that region. That region could be highlighted on the monitor when such an alarm event occurs. Further, that same camera can again simultaneously have an object detection algorithm activated such that if an object such as a handbag (potentially with a bomb in it) were left in view of the camera, an object alarm event would be generated. Again, the region around the handbag can be highlighted on the monitor. (BOB—MORE CLAIMS??)

Once collected, the application software determines how the associated image and other sensor data, such as sound, is processed and transmitted by the system. For example, if there were any motion, the images would be archived on the server. If there were a motion event around the painting, a warning could be transmitted to a guard at a remote monitor guard station and a determination of what was going on around the painting could be done remotely. If an object were detected, a local guard could be dispatched to analyze the bag to determine if it were misplaced or if it was a real threat. , . Other types of simultaneous event detection can also be activated in the sensor/camera such as acoustic (gunshot or explosion) detection, temperature detection, etc.

In the preferred embodiment, all of the transmitted data is entered into an multimedia data archive and retrieval server. The system server is a multimedia situational archival server and is typically located on the network at a central management location. The server stores the transmitted data on a disk drive and optionally on a back-up tape drive or other very large storage array device such robotic tape, optical or high-density disk storage. As each data event, image or frame is received, it is filed with a unique identifier comprising date, time, camera or encoder and/or file information. . This allows full search capability by date, time, event, user, and/or camera on command, greatly enhancing retrieval and reconstruction of events. From an operation perspective, a key aspect of the invention is the graphical user interface as typically displayed on an interactive monitor screen such as, by way of example, a CRT located at a remote monitoring station or a LCD on a wireless portable PDA based monitoring station. This permits the user to search or browse the images in the database and to perform automated searches through the archive for events of interest. In the preferred embodiment, the user interface includes a map of the areas covered by the system and current live images from selected cameras. On screen controls are provided for selecting and adjusting cameras. The screen also contains a series of controls used for searching and browsing. The time and date of the selected image is displayed. The time, date, and type of events are displayed. The user may scan forward and backward from an image, event, or time, and may select another camera to determine the image at the same time and date. In an enhanced system of the preferred embodiment, the selected camera will flash on the map. In an enhanced system of the preferred embodiment the location of an event will also flash on the map, if detected by a video event from a camera, or if detected with another sensor or appliance, such as a legacy alarm system or an advanced network appliance.

The activity level histograms for the various stored images may also be displayed on the screen, giving an immediate visual indication of the change from frame-to-frame or image-to-image. This allows the user to view and analyze motion patterns. In addition, each camera may feed a matrix of regional activity level motion histograms for quantifying motion in different regions or areas of a selected scene. Selective masking may be controlled at the screen level as well. In this case, a user could monitor the activity level of an entire facility not by looking at a multitude of small and busy screen images, but instead by looking at a bar graph display with each of the sensors reporting the overall activity level as a level on a bar graph—looking much like an audio mixer board VU level barograph matrix display for example. The individual bars in this case are showing Video Activity Levels for each camera sensor, and in the mixer board it is showing the Audio Sound Level for each microphone or audio source.

In the preferred embodiment it may be desirable to have the system to automatically switch to real time display of cameras detecting an unexpected change in motion. Specifically, as a camera begins transmission to the server, the display screen will be activated to show the image.

In the preferred embodiment it may also be desirable to have the system automatically switch to the real time display of cameras that are associated with other types of sensors, such as legacy alarm system motion detectors or door contacts that are in or adjacent to the field of view of a particular camera or group of cameras.

This invention also defines a method of incorporating legacy alarm systems such as may have been installed by ADT, or the like. Such an alarm system can be integrated by connecting a reporting printer port to the network via an interface computer or appliance, and interpreting the printer data format to generate events to log into the database and to perform automated notification process on. This technique allows the native interface to the alarm system to be monitored in a conventional manner. The integration can also be accomplished by connecting to the legacy alarm system with a native interface that behaves like the intended alarm monitoring terminal. Thus all of the monitoring would be done through the new integrated system.

This invention also provides a method of incorporation legacy access control systems such as provided by ADT or HID or the like. These systems can be configured to read swipe badges, read proximity badges, read keypad data, unlock strike plates on doors, lock strike plates on doors, control sirens and lights, and other functions. Such an access system may be interfaced using a native control interfaces such as the typical RS-232 interface, or event recording can be accomplished by connection to the usual printer output port. The output data from the access control system can then be filtered or interpreted to a format that can be logged and data format to generate events to log into the database and to perform automated notification process upon. If the interface is a bi-directional interface the system can be configured by the networked system and the access configuration set up at the monitor stations throughout the network with proper passwords. If a printer port is utilized, only output information may be collected, logged, and acted upon.

It is, therefore, an object and feature of the invention to provide a means and method for collecting event data at a remote location, identifying and prioritizing the data, and selectively transmitting the data to selective monitoring stations on a network based on an event prioritization hierarchy.

It is an object and feature of this invention to log an image of personnel attempting to gain access through an access control system, and to log all successful entry attempts and all unsuccessful attempts.

It is an object and feature of this invention to provide a user interface to search the database by specific individual, class of individual, by successful accesses, or by unsuccessful accesses, by specific portal of entry with qualifiers of time, day, location, and the like.

It is an object and feature of this invention to provide an image of those personnel attempting access to a facility along with the results of a search of the database by specific individual, class of individual, by successful accesses, or by unsuccessful accesses, by specific portal of entry with qualifiers of time, day, location, and the like.

It is a further object and feature of the invention to provide a means and method for comparing data generated at a remote location to determine the occurrence of an event and to transmit the data to a selective monitoring station indicating the occurrence of an event.

It is also an object and feature of the subject invention to provide a means and method for collecting video and/or still images of a scene and transmit any change in the scene in near real-time to a remote location.

It is another object and feature of the subject invention to provide a means and method for minimizing the amount of data to be transmitted without any loss of critical change data.

It is also an object and feature of the subject invention to provide a means and method for tagging each block of data with a unique identifier for enhancing storage, search and retrieval.

It is an additional object and feature of the subject invention to provide a means and method for quantifying the amount of change between scenes.

It is an additional object and feature of this subject invention to provide a means and method of quantifying the amount of change between scenes and reporting such as an indication of level of motion.

It is a further object and feature of the invention to provide a means and method for ignoring anticipated or minimal changes in a scene by applying pre-selected criteria.

It is yet another object and feature of the subject invention to permit masking or blocking of specified regions of a scene to further enhance the monitoring, transmission and definition of the changes in the scene of a frame-to-frame basis.

It is a further object and feature of the subject invention to build masks automatically, thus allowing blocking of specific regions of a scene without laborious graphical human input to specify areas that are to be blocked.

It is another object of the invention to correlate motion between two or more cameras to determine if a motion detection event should be determined in order to eliminate false alarms caused by insects or small animals getting close to camera lenses.

It is also an object and feature of the subject invention to provide a convenient user interface permitting all of the functions to be controlled from a single interactive monitor screen.

It is also an object and feature of the subject invention to provide simultaneous access for two or more monitor screens each allowing functions of the system to be controlled by that interactive monitor.

It is also an object and feature of the subject invention to provide a means for detecting the appearance or disappearance of an object.

It is an additional object and feature of the subject invention to provide for notification of the presence of unauthorized events in a monitored zone and for transmitting the notification to selected remote stations on a network on a near real-time basis.

It is a further object and feature of the subject invention to provide for routed notification of events, whereby the location of the incident may be visually located on a map at the remote station.

It is another object and feature of the invention to provide a notification method whereby incidents may be prioritized.

It is an object and feature of the invention to categorize events in order to provide a notification method whereby notification of events can be made in a selective manner.

It is another object and feature of the invention to provide automated selection of notification of the nearest qualified personnel based up on the reported geo-location of potential qualified response personnel, such as may be determined by an associated GPS system, a personnel tracking system, proximity sensors, or any other automated fashion that is interfaced to the network that can report the locations of the personnel.

It is a further object and feature of the invention to provide a notification method whereby the recipients of the notification may be password encoded as defined by the type of incident.

It is an object of the invention to provide a convenient user interface to configure tables of individuals and organizations to be notified along with the techniques used for notification of that individual or organization.

It is an object of the invention to provide confirmation of delivery of a message concerning the event.

It is an object of the invention to provide a notification tree of individuals and organizations whereby lack of confirmation in a period of time by any selected individual or organization will affect a branch up the tree to other backup individuals or organizations until the notification is confirmed.

It is an object of the invention to log dispatch of notification in a log file, and to log confirmation of notification in a log file.

It is an object of the invention to provide event notification using e-mail to e-mail terminals, computers, digital pages, digital wireless telephones, PDA's and other devices.

It is an object of the invention to provide event notification via dial-up telephone to POTS telephones, wireless telephones (cellular, PCS, etc.), numeric pagers, and other telephone hosted devices.

It is an object of the invention to provide WAV file or other recorded file playback of voice messages in the notification process, and the notification to include important information such as the type of event, the location, time, and other significant data.

It is an object of the invention to provide voice synthesis in the notification process, and the notification to include important information such as the type of event, the location, time, and other significant data.

It is yet another object and feature of the invention to provide a notification method wherein the first response to the event is sent to all remote stations notified.

It is also an object and feature of the invention to provide a means and method for selecting stations on a network for receiving event data based on a prioritization of event data.

It is also an object and feature of the invention to provide a means and method for selecting stations on a network for receiving event data based on the type of event data.

It is an object of this invention to provide multiple methods of connectivity of PDA's to the hosting network as follows:

1) Plug-in connections for areas where absolute connectivity is needed, such as a particular monitor desk or station for a guard.

2) Wireless LAN connectivity for completely mobile connectivity in areas covered by WLAN access points, and

3) Wireless carrier connectivity for areas not covered by WLAN access points, such as outdoors on in patrol cars.

It is another object of the invention for the host software on the PDA to select the appropriate carrier for the situation.

Other objects and features will be readily apparent from the accompanying drawings and detailed description of the preferred embodiments.

### BRIEF DESCRIPTION OF THE DRAWINGS

FIG. 1 is a diagrammatic view of an overall system incorporating the features of the subject invention.

FIG. 2 illustrates a sequence of typical events and a histogram constructed for tracking the events for management of data.

FIG. 3 illustrates a further refinement of collected data utilizing a region histogram, a weighted matrix and a motion matrix.

FIG. 4 is an illustration of a graphical user interface as depicted on a typical CRT screen.

FIG. 5 is an illustration of motion histograms.

FIG. 6 is a description of the notification process system and methods utilized for detecting and notifying events.

FIG. 7 is a system overview.

FIG. 8 shows a typical screen on a display monitor.

FIG. 9 illustrates a typical screen with a pop-up control window.

FIG. 10 illustrates a typical screen with a pop-up alarm profile window.

FIG. 11 illustrates a typical screen with a pop-up alarm control system window.

FIG. 12 illustrates a typical screen with a pop-up alarm control system window showing selection of stations activated.

FIG. 13 is similar to FIGS. 11 and 12, and shows the pager selection activated.

FIG. 14 is similar to FIGS. 11, 12 and 13, and shows the e-mail selection activated.

FIG. 15 is similar to FIGS. 11-14, and shows the voice call selection activated.

FIG. 16 is a flow chart of the event notification system.

FIG. 17 illustrates a typical screen with an event setup pop-up window.

FIGS. 18-21 illustrates various reporting functions available through the event setup pop-up window of FIG. 17.

FIG. 22 illustrates a typical view displayed when the view tab of FIG. 19 is selected.

### DESCRIPTION OF THE PREFERRED EMBODIMENT

The subject invention is directed to a method for identifying the occurrence of an event at a 10 remote location, prioritizing the event, and then, based on the priority, forwarding the event to selected stations on a network. Basically, the location, type and priority of event are “tagged” at the point where a sensor picks up the event and event data is then forwarded only to selected stations on the network as required by a priority hierarchy. This permits a large amount of data to be collected at the site of a sensor while minimizing transmission of the data to an “as-needed” basis, reducing the overall bandwidth requirements of the system. As an example, while periodic data may be gathered at a sensor, only data indicating a change in condition will be transmitted to various monitoring stations. In addition, monitoring stations are selected based on pre-established hierarchy, typically managed by a system server.

On aspect of the invention provides for continuous or selective monitoring of a scene with live video to detect any change in the scene while minimizing the amount of data that has to be transmitted from the camera to the monitoring station and while at the same time maximizing storage, search and retrieval capabilities. Another aspect of the invention is a method of event notification whereby detected events from sensors, sensor appliances, video appliances, legacy security alarm systems and the like are processed and a comprehensive and flexible method of notifying individuals and organizations is provided using a plurality of methods, such as dial up telephones, cellular and wireless telephones, pagers, e-mail to computers, digital pagers, cellular phones, wireless PDA's, and other wireless devices, and direct network notification to workstations based on I/P addressing such as to workstations, digital pagers, digital cellular phones, wireless PDA's and other network and wireless devices. The preferred embodiments of the invention are directed to a method for collecting, selecting and transmitting selected scene data available at a camera to a remote location includes collecting the image data on a preselected basis at the camera and defining and transmitting an original scene to the remote location. Subsequent data of the scene is compared to the data representing the scene in its original state. Only subsequent data representing a change is the original scene is transmitted. Each transmitted data scene may be tagged with unique identifying data. The transmitted data is stored for archival, search and retrieval. The selection scheme of the invention also permits notification of the detected events to be sent via a network to selected monitoring stations.

The subject invention is directed to several distinct aspects of event data collection and retrieval, namely: (1) motion and object detection, (2) data archive and retrieval, (3) legacy sensor and alarm data importation, (4) event filtering to qualify alarm and supervisory events (prioritization), (5) notification, and (6) user interface technology.

### MOTION AND OBJECT DETECTION AND DEFINITION

One aspect of the invention is directed to a method for continuous or selective monitoring of a scene with live video to detect any change in the scene while minimizing the amount of data that has to be transmitted from the camera to the monitoring station and while at the same time maximizing storage, search and retrieval capabilities.

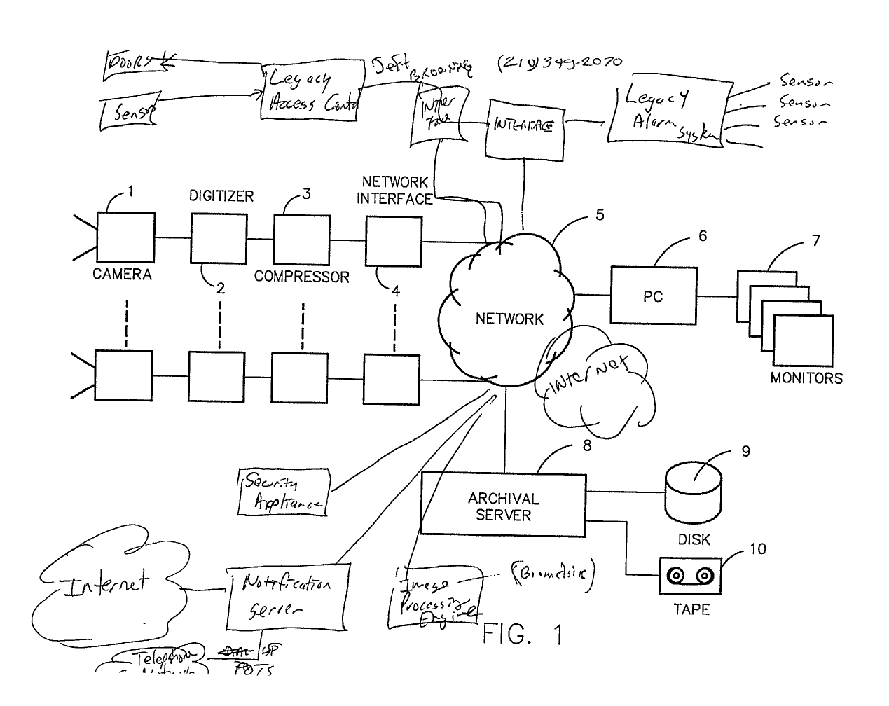

The system employs a plurality of digital cameras and encoders with their associated digitizers and video compressors, all on a common network such as a local area network or LAN, wireless LAN (WLAN) or wide area network (WAN). FIG. 1 illustrates the concept. Individual cameras 1 produce a video signal representative of a desired scene. The resulting video signal is converted into digital form by digitizer 2, compressed by compressor 3, and conveyed to network 5 via network interface 4. As illustrated, more than one such camera and associated digitizer, compressor, and network interface may be deployed on the network. Individual digital cameras or video encoders may be commanded to capture, digitize, compress and send motion video to a viewing station comprising a computer or processor such as the PC 6 and one or more monitors 7, upon request by a user. In addition, these same individual cameras may be configured to send higher-resolution still-frame ‘snapshots’ from any particular camera to an archival server 8 also located on the network. The archival server stores these images on a disk drive 9 and, optionally, on tape drives 10.

Cameras may be configured to send a still-image to the archival server periodically at preset intervals, say, every second. While this approach has utility, it is wasteful of the server storage media since many captured images are unchanged from the previous image captured by that camera.

Configuring the cameras to send only those images that have changed significantly from the previous image may substantially reduce storage requirements. Such an approach effectively detects the presence of motion in the scene captured by the camera. The level of activity can also be monitored. By way of example, certain levels of activity may be considered normal even though they may deviate from a previous image. An example of this is people walking through the halls during a class change time period. In this case, the system may ignore activity during a normal class change period by may compare the image prior to the period with an image immediately after the period to determine if there is a residual change once the hall is cleared, such as an object being left behind or a student being present when the hall is supposed to be clear.

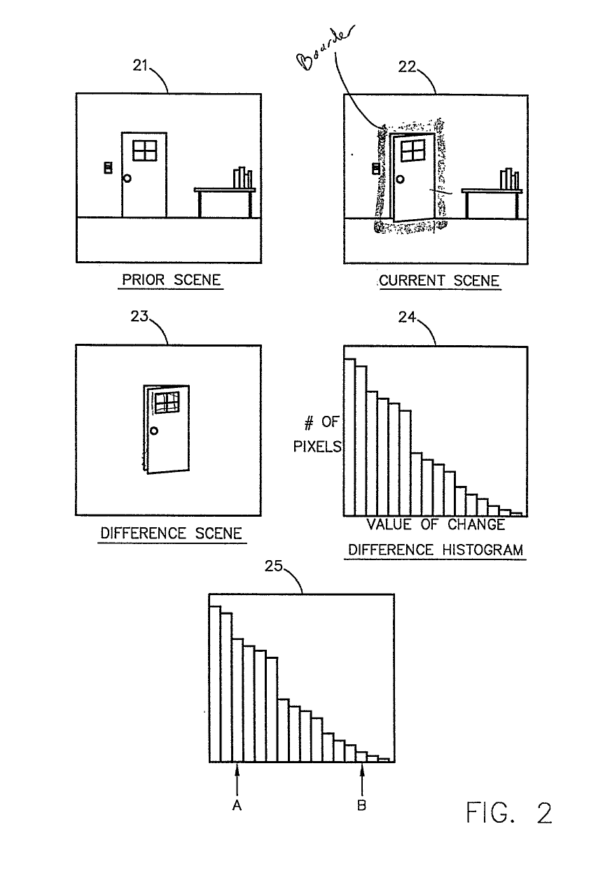

FIG. 2. Illustrates the concept. A camera has previously captured prior scene 21, and has stored it in an image memory. Subsequently, the camera captures current scene 22, and stores it as shown. The camera then calculates the difference between the two scenes, and produces a ‘Difference Scene’ 23 as shown. The Difference Scene may then be compressed using, for example, JPEG or any other suitable compression mechanism. The Difference Scene may then be transmitted to the archival server for storage and subsequent analysis. Additionally, the Difference Scene 3 is statistically summarized by means of a histogram 24. A histogram is not the only possible method for motion detection. A variety of regional motion detection schemes are possible and would be of use in this invention. For example, the two respective scenes may be differenced without generating the statistical histogram; any inter-scene pixel difference above some defined threshold would be indicative of motion. Alternatively, the DC terms for each macroblock in a discrete cosine transform or wavelet transform of the respective scenes may be interframe-differenced to detect motion. Neither of these implementations differs in spirit from the invention.

This histogram 24 describes the Difference Scene 23 in terms of degree of change; the Y-axis represents the magnitude of a pixel's inter-scene change, while the X-axis represents the number of pixels that changed by that much. If, for example, there had been no motion or other changes between two scenes, the histogram would probably show a non-zero value in the first few columns (due to camera noise) and a zero value in the remaining columns. This would indicate that some pixels changed by a small amount (the camera noise), but that no pixels changed by any more substantial amount. If there had been substantial inter-scene motion, however, the histogram would have many more non-zero ‘bins’ farther right of the Y-axis. This indicates that some number of pixels had changed by a substantial amount, indicating motion.

The histogram 25 in FIG. 2 allows the system to quantify the amount of motion in an image. In the invention, an algorithm sums all the pixel value changes between a pair of columns in the histogram, represented as A and B in histogram 5. Assigning a non-zero value for A effectively suppresses low-level camera noise. If the summed pixel change total between values A and B exceeds some threshold value, the algorithm determines that motion has occurred. The system controller then commands the current still-image to be compressed and to transmit via the network to the archive server.

Note that the algorithm need not analyze the color components of the camera video. In actual use, the algorithm need only analyze the luminance (gray-scale) differences between the captured frames. Also note that the algorithm need not analyze pixel differences for every pixel in the captured scene. Difference analysis of every single pixel may be time-consuming and may unnecessarily over utilize the computing resources within the camera. For these reasons, it is preferable to decimate the captured scenes by some amount prior to the difference analysis. For example, the algorithm might use every second pixel horizontally and every other line vertically, or every fourth pixel and every fourth line, etc. Such decimation results in substantially faster detection without meaningful loss of motion detection resolution.

The histogram may be profiled such that patterns emerge. For example, during a class change at a known time it is expected to see a certain high motion profile. Between class changes another lesser motion histogram profile is expected. If the actual histogram differs from the expected histogram at any given time, an alarm can be generated, cameras activated, and so on. For example, a fire or someone producing a weapon would likely produce a lot of “panic activity” thus an increased profile and would trigger the alarm event.

An array of video motion detectors can be used to drive the histogram chart. One screen could show the entire level of motion in all cameras in, for example, a school. This could look somewhat like a big audio spectrum VU meter display, but instead of frequency bands it would be specific cameras. This would be configured, for example, such that the level of motion would drive the histogram display higher.

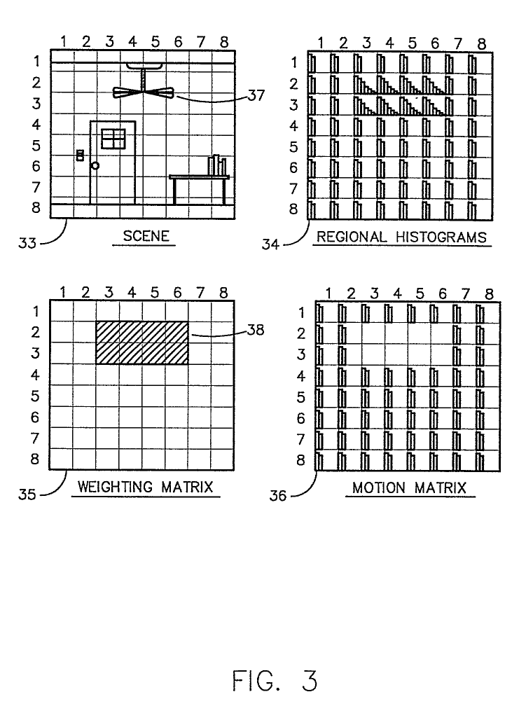

A further refinement of the invention is depicted in FIG. 3. A captured scene 33 contains a continually moving object, such as the ceiling fan 36. Since this object's motion is not of general interest, it is not desirable that its motion should trigger the generation and transmission of still frame images. This would waste storage space on the archive server. To avoid this, the scene 33 is divided into some number of regions. In the illustration, the scene is divided into 8 columns and 8 rows, totaling 64 distinct regions in the scene. Instead of generating a single motion histogram representing the entire scene, individual motion histograms are generated for each separate region. The resulting matrix of regional histograms 34 indicates which regions of the scene contain motion, and indicates the degree of motion in each region. This regional histogram matrix is then modified by a weighting matrix 35. In the simplest case, this matrix contains a value of 1 in each region, except for those regions where known motion is to be masked. The regions to be masked contain a value of zero. Each regional histogram value is multiplied by its' corresponding value in the weighting matrix. The resulting motion matrix 36 thus contains 64 individual motion histograms, and the regional histograms in the masked regions contain a value of zero. Thus, motion of the fan is not detected as motion, and does not cause unnecessary transmission and storage of still image data on the archive server. Note that the weighting values used for each region in the weighting matrix need not be restricted to binary values of zero and one. The actual weight values used may be continuous variables between zero and one (or represented as 0% to 100%). This allows some regions of a scene to be given greater sensitivity to motion, as compared with other regions.

Assignment of the regional weighting values in the weighting matrix 35 in FIG. 3 may be accomplished in a variety of ways; in the preferred embodiment a remote user assigns these values through the use of a Graphical User Interface (GUI). For example, the GUI may display the image as currently captured by the remote camera, and overlay upon the image a grid representing the image regions. The user may then click a mouse on the selected region, and then assign a weight value between 0 and 1 via a graphical slide bar or other suitable mechanism. Weights thus assigned may be represented to the user by a variety of means; the preferred means is to proportionally increase or decrease the brightness and/or contrast of individual regions according to the current weight. Alternatively, the selected regions may be surrounded by a highlighted border or overlaid with a meaningful symbol. In either case, the matrix of weighting values is then sent to the camera for use in the previously described motion detection algorithm.

The regional weighting values may also be generated automatically by a variety of means. For example, the algorithm may be operated temporarily in a ‘learn’ mode, wherein the algorithm notes and records areas of motion, and thereupon masks those areas off. Alternatively, the system may be adaptive. In other words, if the algorithm detects motion in certain regions on a daily basis, it may then automatically decrease those weight values, reducing it's sensitivity to known regions of daily motion. In either case, when the system ‘learns’ areas of motion, it may then surround the identified motion zones with an additional ‘guard band’, to allow for some variation in the apparent position of the moving objects and thereby reduce the occurrence of false triggers.

It is likely that external, routine events may be detected as motion, causing false alarms. One category of such events might be when room lighting is turned on or off. To prevent this, the server may be instructed by the lighting system when the lights are turned on or off, and then ignore any incoming image data from the affected camera, or instruct the camera to ignore motion for the next few seconds. Alternatively, the server may be used to control the lights in response to inputs from the lighting controller or the individual light switches. Of course, if the motion detection algorithm is adaptive as previously described, it will ignore any regular, daily changes in light status anyway.

Sunrise and sunset may be more sources of false detection of motion. If the system is adaptive as previously described, then these events will be ignored. Also, since these events are so gradual, the system will not notice significant inter-scene differences if the inter-scene time is kept small. Note that when transitioning from a well-illuminated scene to a poorly illuminated scene, it will be necessary to change the difference threshold value used for motion detection. This is necessary to maintain constant overall motion sensitivity.

When motion is detected and an image is transmitted from the camera to the server, the camera additionally sends a short file containing the motion matrix, described above. The file also contains a calculated value representing the total degree of motion for the scene. This allows the server to keep all motion information, detected by all cameras in the system. This is a useful feature, allowing servers to analyze various motion patterns or to retrieve desired images with greater efficiency, as subsequently described. Note that this motion matrix, and the calculated overall motion variable, may be reduced to a binary motion indication for each region. In other words, regions with motion are represented with a ‘one’ bit, and others are zero. The overall scene motion bit is then simply the logical OR of all regional bits. In the above example, the entire scene may then be represented with only 9 bytes, thus reducing network bandwidth and server storage space.

A further refinement of data compression will also reduce the large amount of multicasting required to support the encoder array of a multiple camera/multiple sensor system utilizing network routers. As an example, a system with 100 encoders/cameras for would require multicast traffic estimated as follows:

100×256 KBPS for QSIF=25.6 MBPS

100×1 MBPS for SIF=100 MBPS

In addition, unicast traffic for JPEG at 100×64×8 KBPS=51.2 MBPS

The aggregate data rate if ALL of this is dumped on a LAN at one time is 176.8 MBPS.

In the subject invention, this traffic may be reduced by operating the SIF's by turning them off and on upon demand. Specifically, when an application such as the guard station software is commanded to call for video from a specific camera, the application would instruct the camera or a centralized controller to tell the camera to start streaming the SIF. The fact that the SIF is only turned on when an application is going to use—display the video—will save bandwidth. In this example, if all guard stations were watching 4×4 video displays that are exclusively Q-SIF, none of the SIF sources would be turned on thus saving 100 MBPS of multicast data from being placed on the network.

In the present invention, using routers and also switches that are coordinated by routers, the multicast traffic will not be allowed to pass the routers and/or switches unless the applications request the data. This allows routers to decide to allow the never ceasing multicast streams to pass through or not would be a periodic request for the stream to be sent that is coming from the application at the client. The request would be passed by the network back through switches, routers to toward the destination, and would keep the channel open.

This permits routers to control the dispatch of multicast streams into a network. Encoders could also switch the SIF (and QSIF and JPEG) stream switching in a similar way, eliminating the need for routers. In this case, the request that is coming from the application would be passed all of the way back to the encoders. If the encoder sees the request for SIF (QSIF or JPEG), the encoder would turn it on and transmit. If the request does not come for a set time period, the encoder would time out and the SIF (QSIF or JPEG) stream could be squelched.

The detection of motion may be used to automatically “switch” one or more cameras on to the main display window of a guard station screen. This can be a single camera full pane display or an automatic “switch” to a plurality of cameras to provide a matrix of display panes in a split screen display, showing all motion activated cameras simultaneously. The resulting matrix shows only cameras that have activity, or perhaps have had activity in the last given amount of time. The use of motion detection from multiple cameras to build a display matrix of cameras that have detected motion, permits building in a temporal sequence. Thus a guard could track a person as he walks down a hall from camera to camera, activating a new window (and flashing another icon) as each new camera is triggered.

The use of motion detection from multiple cameras to build a still frame matrix of trigger activity over a period of time permits recording of a history of a person's activity to be archived on sequential panes of a split screen. This permits the selection of any sequence of playback video and dissection of the stream of images with placement of sequential still frames on sequential panes of a split screen. This allows viewing of temporal events by scanning from one pane to another. Since the time of each image is also recorded, the time between images can be reviewed such that non-sequential images, such as every forth, are displayed. This also tracks the speed at which a sequential event is taking place, or provides a temporal “zoom”. “Temporal zoom control” can be adjusted, thus causing the database to repaint the images based on the new temporal zoom factor.

### EVENT ARCHIVE AND RETRIEVAL

The database holds a record of images, motion, triggers, alarms, and event processing actions that have been taken. As the database is searched and/or played back forward, reverse, fast or slow, all of the associated information such as images, motion levels, triggers, alarms, and event processing can be displayed in synchrony with each other. After the fact information can be added at specific time locations also, such as Word Files, Power Point Images, e-mails, and the like. These can then become part of the master database recording information about image events. In addition to collected data, created data may also be retrieve. For example, the histogram may be retrieved from the database, wherein the histogram shows the data in the same manner as it did when created. The playback can be in real time, faster, or slower than real time. Playback can also be forward or backward. This permits searching for “trigger” events in the database, then playing back in real time, faster, or slower than real time.

In FIG. 1, cameras capture, compress, and transmit images via a network 5 to a centralized archival server 8. The server supports identification and storage of incoming images, and supports client-side retrieval of stored images. It should be understood that other events detected at remote locations and generating signals in response to such detection can also be incorporated in the system for transmitting event data via the network 5 to the server 8. Since such event data is generally a signal from a specific sensor, e.g., a smoke detector, fire detector, panic button, pull alarm or the like, the data signal will indicate both the type and location of the event. Therefore, on a much simpler basis, the following discussion is equally applicable to the archiving and retrieval of these simple ON/OFF event signals.

Because of the immense amount of data relating to image collection and transmission, images must be collected, transmitted and stored in some fashion that supports efficient transmission, use and retrieval. For example, a client may wish to see all images captured from all cameras over some selected time span. Or, a client may want to view all archived images from a selected camera over some selected span of time. Alternatively, the client may wish to see images from all of a group of overlapping cameras over some time span. Since these database inquiries are all slightly different, an efficient storage and indexing mechanism is required. A variety of database software is in common use, as well as a variety of commonly used indexing methods. For the invention, any of these methods are useful for storing, identifying, and retrieving the image data. In the present invention, the full pathname of the various image files is created by combining information describing date, time and the identity of the camera. In particular, the pathname takes the form YYYYMMDD\HHMM\CAM_YYYYMMDDHHMMSSmmm.jpg

wherein:

DATE:

YYYY=4-digit year

MM=2-digit month

DD=2-digit day

TIME:

HHMM=4-digit hours and minutes

Ss=2-digit seconds

CAMERA (OR SENSOR) IDENTITY:

CAM=Camera ID number

ELAPSED TIME OF IMAGE:

mmm=3-digits milliseconds

FILE EXTENSION:

.jpg=JPEG file extension

It should be noted that the DATE, TIME and IDENTITY components of this sequence are also useful for the ON/OFF appliances or devices. This method of assigning the pathname has several advantages. First, all files pertaining to a given date are stored in one logical folder on the storage media. This facilitates disk backups, since all images from a given date are in one place. Providing a second-level folder describing time-of-day speeds image retrieval, since all images in a given time interval may be rapidly located or cached. Finally, since the actual filename codes the date, time, and camera number, all image searches may be accomplished with a simple ‘wildcard’ search method.

This scheme of having the server assign time stamps to the camera data is sufficient for local cameras that have negligible electronic time delays between capture and storage of images. Remote cameras may be connected via circuits that have long propagation delays, unknown propagation delays, or variable time delays. These delays in transmission of data would provide a false sense of time in that the server is recording the received time, not the captured time of the data. For example, the Internet is subject to variable delays based on system loading, equipment status and the like. Typically the camera will have an on-board time source that is reliable and synchronized to a “national” source. This time should be passed with the collected data, and should be part of the record. As data is reconstructed, the source time should be utilized in comparing event data. This is not to say that received time is not important. It is meaningful to know at what time the data was delivered to the server.

The file naming convention used here is intended to be exemplary only. It should be well recognized to those skilled in the art that many other techniques of file naming, or the use of a database using keys not filenames, may be implemented.

In the preferred embodiment of the invention, the server is responsible for assigning these path and file names. This relieves the cameras from needing to maintain knowledge of time and date. The server maintains knowledge of time and date through the use of NTP or SNTP protocols, over a suitable network such as the Internet. Time accuracy on the order of tens of milliseconds is thus maintained. Furthermore, the server updates his SNTP clock at regular intervals, nominally every 5 minutes. This prevents the server's internal clock from drifting so far that an image captured immediately after an SNTP clock correction would have a timestamp earlier than the prior image.

In some cases, the camera may be located some distance from the server, and may be connected to it via some network with lengthy and variable latency. In these cases, each camera must be equipped with its own local clock and SNTP client. These cameras append their local time to the image data sent to the server, so that the server may accurately time-stamp the image file.

Cameras thus need only send the actual image data, and the server assigns an appropriate pathname to the image. The actual transaction between the camera and the server consists of the following sequence:

| | CAMERA | SERVER |
|---|---|---|
| 1. | Detects Motion | |
| 2. | Sends socket request to server | |
| 3. | | Assigns a socket ID number |
| 4. | Sends image data to the assigned | |
| | socket ID | |
| 5. | Closes the socket | |
| 6. | | Formulates an appropriate path & |
| | | filename |
| 7. | | Places image data into the newly- |
| | | created file |
| 8. | | Writes the file to disk. |

Whenever a camera sends image data to the server, the camera also sends the motion matrix, previously described, to the server. These are short files, and use the same file and path names as their corresponding image files but with a .MOT extension. This information is subsequently used by the User Interface when analyzing motion history and patterns.

### LEGACY SENSOR AND ALARM DATA IMPORTATION

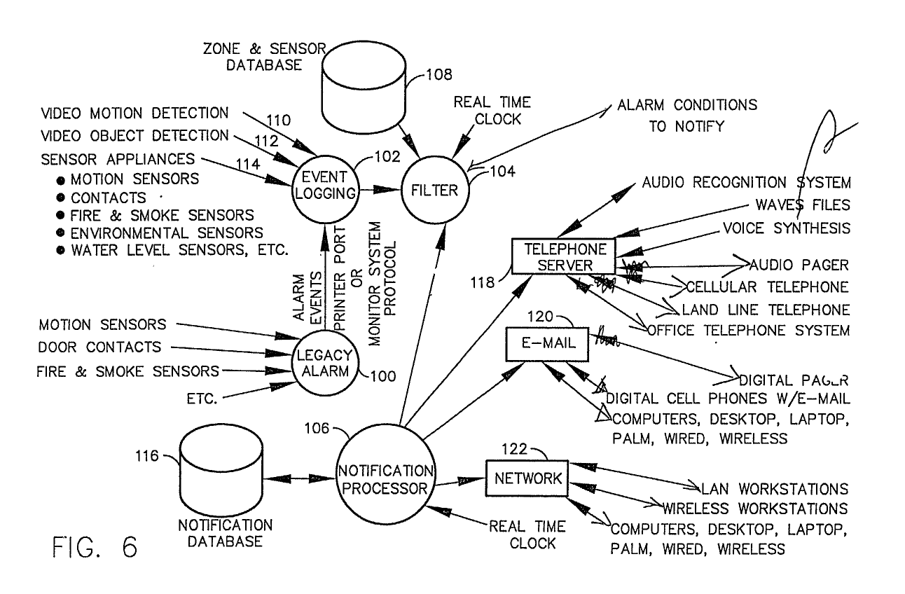

One of the important features of the system is that legacy devices may be incorporated into the system whereby the signals generated by such devices may be transmitted, archived, and retrieved using the management methods of the subject invention. This is particularly useful when the system is installed as a retrofit to update existing systems having various legacy devices such as, e.g., fire alarms, motion detectors, smoke sensors, fire sensors, panic buttons, pull alarms and the like. The system is also useful when used in combination with legacy closed-circuit analog security cameras. In the case of the cameras, the signal is digitized prior to transmission. With specific reference to FIG. 6, the system is adapted to incorporate one or more legacy devices 100, which are basic ON/OFF devices adapted for generating a signal when a monitored event occurs. This can include, but is not limited to, motion sensors, door contacts, smoke and fire detectors, panic buttons or pull alarms, and the like. As is typical of these devices, they often provide a local signal such as a siren or other sound signal at the site of the device and in some cases send an activation signal to a remote, hard-wired location. In the present invention, these devices are connected to the network and the activation signal is sent over the network when the device is activated. Using the above described management techniques, the signals are identified for location, time, and type of signal. This is then sent to the central server 8 and monitor server 6 (see FIG. 1) for management of the event and the related activation signal. Basically, and as will be further explained herein, the activation signal(s) are transmitted via a network to the server systems, which include the event logging function 102, appropriate filters 104 and a notification processor 106 for prioritizing the event and managing the transmission of an event signal to selected monitoring and archiving stations on the network. Specifically, it is important to note that once the signal identification, transmission and management methods of the subject invention are incorporated, the system is readily and equally adapted to manage the various network security appliances designed for the system, digital camera systems, and the legacy analog cameras and security devices of the prior art.

In one embodiment of the invention legacy system may be included in the system of the subject invention by utilizing the printing output port for recording status of legacy systems. In many of these systems, the printer output is via an RS-232 port. The system of the subject invention intercepts the printer output signal and transmits it to the system server where it is time-stamped and logged along with other data. This permits synchronization with system data for research and playback purposes. The server may also be set up to interpret this legacy data and generate alarm and notification signals as described later herein. For example, if a perpetrator accessed a door at a defined unauthorized time the legacy system will detect the opening of door contacts and generate an output print signal for generating a report. This signal is sent to the system server and notification will occur as with other system components.

The legacy systems can also be used to provide identification of authorized use as well as unauthorized use. For example, if an access point permitted authorized password or card access, the authorization signal would be sent to the server for indicating that the access is authorized, thus overriding any notification signal that would be generated in the event of unauthorized access. The use by authorized personnel would also be logged with personnel identification, type of entry, time and date.

### EVENT FILTERING TO QUALIFY ALARM AND SUPERVISORY EVENTS (PRIORITIZATION)

FIG. 6. also depicts the prioritization scheme of the subject invention. Specifically, the methods of the subject invention not only permits an event to be identified, transmitted, monitored and archived, but also permits management of the event data to send the various signals to the most logical, selected monitoring stations for response and to determine the priority or hierarchy of the event in order to promote efficient and timely response to and management of the event data. In the exemplary embodiment it is assumed there are multiple sources of event signals including, but not limited to: (1) the legacy alarm devices as indicated at 100, (2) camera sensors, either digital or analog, for providing either motion detection as indicated at 110, 112 and (3) various sensor appliances, including but not limited to motion sensors, contact switches (door sensors, pull alarms, panic buttons and the like), fire and smoke sensors, environmental sensors, water level sensors and the like, as indicated at 114. All of the event signals generated by these various devices and appliances are sent to the central sever (see FIG. 1) where they are logged and archived.

The signals are also filtered to determine their priority hierarchy at filter 104. By way of example, if activity is intended to occur in a specific zone during a specific time period, the detection of motion in that zone would receive a low priority. As another example, using the histogram methodology and masking methodology also discussed herein, a certain level of activity may be required to identify a priority level for the event to indicate a notification and response is necessary. This same methodology applies to the various sensor appliances and legacy devices as well. Again, by way of example, if a door is expected to be in use during a certain time window, a signal from a door contact switch would receive a low priority.

The filter 104 manages this using the priority data entered in the zone and sensor database 108 provided in a suitable memory format in the central server. When the appropriate priority is indicated, and a decision is made to notify a remote station of a specific alarm or event condition, this is released from the filter 104 to the notification processor 106 and the event notification takes. The process for notification is described below.

Masks can be built automatically. The software builds a motion mask during a controlled period of time, then any motion detected in a defined region over a given threshold would set the mask. For example, the ceiling fan can be turned on, the detection armed, then any areas of the scene where the motion of the ceiling fan was detected would set bits in a mask. Then, when the system is armed normally, the bits in that mask would be used to block motion alarming because of motion caused by the fan blades. The automatic mask generation process may be enhanced by enlarging the mask area slightly such that there is a guard zone or safe zone created around the known motion to protect against false triggers from such items as the blades going slightly out of balance, the camera voltages drifting slightly and causing the magnification to vary, focusing issues and the like. During mask generation, an overlay of the image representing the mask area can be built by the software for the operator to review on screen at the monitoring station. This could be portrayed as an outline box around the mask area, a shading change, superimposed symbols, or other common highlighting technology.

In those regions where automatic timers on lighting generate motion events, coordination between the light controls and the surveillance system is managed to prevent false alarms. This is accomplished by having the alarm system control the lights and by using different criteria for event detection with the lights on versus lights off. Also, the alarm system can be configured to sense the signal controlling the lights to confirm that such a video change is authorized at that time. Cameras that have sufficient sensitivity and/or auxiliary illumination sources such as small bulbs or infrared illuminators can be used such that video surveillance may continue with normal lighting off.

Outdoor illumination changes will be passed to the interior through translucent windows and translucent doors. These changes will likely be gradual (exceptions being small dense cloud passage, over flying aircraft and other unusual occurrences). The system may prevent these from creating alarm conditions, as well. Detection of contrast changes within the scene will be interpreted as motion, however changes of overall brightness of the non-black areas of the scene will be considered natural illumination changes. Specifically, an overall change in ambient lighting is considered normal whereas sudden changes in small areas of the zone are considered abnormal, alarm triggering events.

There are two methods for defining mask motion data. It is possible to the values before thresholding such that the motion amount is preserved for future analysis, thus automatically defining a threshold. Also, a binary matrix may be generated after thresholding such that only motion locations, not amounts, is preserved. Both methods may be used with equally satisfactory results. Preserving the motion amounts can provide data that would allow “rerunning” motion detection after the fact with any threshold value desired. Other analysis of the data, such as false alarm analysis, can be better accomplished using this method. However this requires more data storage. Storage of binary motion data only preserves storage space. Depending on application and on server capacity, either system is adequate for the purposes of the subject invention.

The automatic mask generation process may be enhanced by enlarging the mask area slightly such that there is a guard zone or safe zone created around the known motion to protect against false triggers from such items as the fan blades going slightly out of balance, the sensor voltages varying slightly causing drift and focus issues, and the like. During mask generation an overlay of the image representing the mask area can be built for operator review and modification.

In the preferred embodiment the video image from each camera is subdivided into a plurality of sectors. This permits each sector to be evaluated independently for motion. This allows for better analysis and recording of motion. The motion is then stored by sector on the database. This allows after-the-fact searches of the database for motion in selected areas only. This avoids decompressing and analyzing each and every frame for selected areas—which is a time consuming process. This may be implemented by segmenting the scene into sectors, such as 16 by 16 pixel areas. Each such area in the scene will then have a bit (if only on/off triggering is implemented) or a word (if variable threshold motion detection is implemented.) The collection of all of the bits or words for the entire image would be stored uncompressed or with simple (non-time consuming) compression. A search for selected motion events can then occur by reading only the motion maps without decompressing the scene.

This technique may also be integrated into inter-frame coding techniques where only certain frames are updated as part of the compression process. If that is available, then the process of updating a frame could flag a search bit.

Use of the sectored motion detection permits highlighting a trigger area in a scene that has an event indication. For example, if a door in a large room is opened, the area of the door will be highlighted so the operator can immediately see what triggered the motion detection. This also permits motion detection to track the movement of an individual through a building. Specifically, a “bread crumb” trail can be left.

The actual sectors triggered in an image can be mapped to the map based on the three dimensional viewing angle of the camera as associated with the two dimensional map itself, thus allowing a more accurate indication of motion or a more complete “bread crumb” trail can be left. For example, ceiling cameras in a gymnasium can monitor the “floor plan” of the gym. The sectors triggered map to specific locations on the map. This is especially useful with cameras pointing straight down, but also holds true of camera angles.

A mask may also be used on the sectors to activate, deactivate, or weight the sector in determining an alarm condition. For example, a window on a locked door may show motion on the outside of a door, and it could be desired that motion seen through a window is not defined as an alarm condition. The mask can be used to block triggering from motion as seen through the window. This is accomplished by picking the sector or sectors that mask the window and deactivating it for a trigger event.

A graphic drawing tool to draw around areas on a scene that are to be considered or not considered for trigger events can generate a custom sector, or can select a set of predefined sectors that are used to create “the best” mask fitting the scenario. An example of excluding motion detection by masking is a window in an outside door that is desired to be masked such that it does not detect motion. An example of including motion detection by masking would be aiming a camera on paintings in a museum at an oblique angle, and setting masking such that any motion in the area of the painting would generate a motion trigger. The creation “zones” are monitored by combination of cameras and/or camera sectors. Zones can be activated or deactivated independently.

Sectors within one camera can be mapped to multiple zones. For example, in a museum one zone would be defined exactly where a painting is located. This zone would be activated essentially all of the time—only being disabled with special authority by the curator. The rest of the scene would be mapped to another different zone. This zone would be activated when that portion of the museum is closed, such as after hours. Then, in this example, after hours the entire scene—the paintings and the surrounding areas—would be activated.

### NOTIFICATION

An important aspect of the invention is the ability to generate and transmit a notification signal in response to the presence of motion in a monitored zone. Specifically, when a notification signal is generated by the filter 104, selected event signal is transmitted over the network as controlled by the notification processor 106. The signal incorporating this data also identifies the time, date and location of the transmitted event data. This signal can be sent to any remote location on the network. For example, if a particular camera detects a difference signal and starts sending still image data to the archival system, the same signal can be sent to a guard station and can be used to trigger an audible and/or visual alarm at the guard station, with or without the image component of the signal. A display can identify the date, time and location of the origin of the signal based on the information embedded in the image signal generated upon the detection of a monitored motion.

This scheme can be simple and indicate a motion presence somewhere on the system, requiring follow-up to determine type and location. It can also be sophisticated to the point of not only identifying the time and location, but also the degree of activity using the histogram comparison scheme discussed above. More sophisticated systems can interpret the transmitted image data to determine the level and type of response required and then transmit the notification only to the appropriate response team.

As more particularly shown in FIG. 6, a notification database is provided in memory 116 and is accessible by the notification processor. When a notification signal is generated by filter 104, the notification processor will access the database provided in notification database 116 and determine where and how notification should be transmitted by matching the specific notification signal with the notification database. By way of example, if a fire alarm is set off, the notification signal from filter 104 would indicate the time the signal was generated, the location of the device and the type of alarm generated. The database stored in store 116 would match this signal with notification information. In this example, the database would indicate that a fire alarm generated at a specific location at a specific time requires, for example, the following notification response:

1. A dial out telephone message to the appropriate fire station via the telephone server 118 and key personnel associated with the facility where the alarm is located;

2. An e-mail message to key personnel via e-mail server 120;

3. A general broadcast of the event data to selected stations on a wide area network the network gateway 122.

As indicated in FIG. 6, numerous event notification schemes are possible, utilizing current device technology. The various notification server gateways 118, 120 and 122 are connected via standard circuit technology to, by way of example, audio recognition systems, wave files, noise monitoring systems, audio pagers, cellular telephones, historic land line telephone systems, closed circuit telephone systems, PDA's, digital pagers, digital pagers and/or cell phones with or without e-mail capability, computer servers on the network, LAN workstations, both wired and wireless, and the like. Where graphic output is available, the notification signal can include a map, and when available, an image of the event through the use of the surveillance cameras. One of the significant advantages of the notification system of the subject invention is the ability to selectively manage the type of data transmitted and the stations to which the data is transmitted, greatly minimizing the use of available bandwidth. For example, graphic information would be sent to a computer server station but not to an office telephone system.

Another advantage is the ability to control the transmission of data based on certain external conditions. By way of example, a specific notification signal may be sent to the office telephone system during certain periods of time but not during other periods of time. Alarms can be set by zones and master zones including specific zones.

The notification hierarchy of the present invention also lends itself to other management functions. By way of example, key personnel will have access to certain information and certain functional capability based on pass code identification. Such personnel will have the ability to activate and deactivate alarms, to access related event information and to expand or restrict the notification process. All of this activity will also be logged as separate events at the event logging function as indicated at 102. Notification tables provided in the notification database 116 may be used to control the notification hierarchy and also to monitor response from the recipients to indicate that a positive response to the notification signal has been received. For example, a notification signal may be initially sent to identified key personnel. If such personnel respond and identify themselves additional notification recipients may not be activated. If such personnel do not respond, in a sequential fashion the notification system would move to the first backup, the second backup, and so on until positive identity and response is established.

It is an important feature of the invention that events will be flagged on graphic map displays where map monitors are provided. An event icon can flash on the map at the location of the event detector device, appliance or camera. The icon can also identify the type of event, such as a fire, smoke, or other condition. An audible alarm can be activated. The icon can visually indicate whether or not a response to the notification signal has been generated over the notification network and the priority of the response.

In addition to an indication of video motion detection generating a flashing icon on an associated map, the icon can be used in a qualitative manner as well. An indication of more or less motion can be made by flashing the icon at different rates depending on the amount of detected motion, or by changing color, or by changing the icon from a simple one like a “:” to a “+”to a “#” to a “*”, or other indicators. Viewing a map with this kind of display would not only point out where motion is occurring, but also how much activity is occurring in given areas.

It should be noted that in the preferred embodiment, playback of retrieved images from the database will playback motion detection data in the same manner as originally displayed when generated. Specifically motion data from the database is displayed such that the icons flash in the same manner that they did when the data was originally generated. During playback, triggering events can be flagged with special, flags sprites or icons to indicate what actually caused a trigger.

With specific reference to the various exemplary communication methods discussed above, the following is an example of how the system may operate:

1) Notification via e-mail—when the notification server detects an event that requires notification, and when the notification is done by e-mail, an attachment to the e-mail can be an image file of the exact image captured at the time of the event and at the location or locations of the event can be attached or included in the e-mail such as a JPEG or Wavelet image.

2) As in the above, more than one image can be attached, such as the image one second before the trigger, at the trigger time and one second after the trigger. This is an example. The exact number of images and the exact timing between images can be anything.

3) A user interface that allows the number of images attached to an e-mail to be selected, and/or the time interval between the images to be selected.

4) As in (1) above, a “full” motion video clip can be attached to the e-mail, such as a MPEG file. This clip can be of any particular length, and may start at the time of trigger, or before, or after, and can run for any amount of time. A user interface that allows the length of the full motion clip and starting and ending deltas can be selected.

5) In all of the cases above the e-mail and attachment can be sent by wire connection LAN, wireless LAN, or WLAN such as CDPD or cellular.

6) In all of the cases above, the recipient system can be a fixed computer, a portable computer such as a laptop, palmtop or PDA class machine.

7) Attached image clips can be annotated with the time at which the images were captured.

8) Attached motion clips can be annotated with time, and the player can show the time that particular frame which is frozen is displayed. Playing the video forward from that point will cause the player to show the time moving ahead in synchronism with the video, playing the video in reverse will cause the play to show the time moving backward in synchronism with the video.

Administrators and roaming guards or security personnel may be equipped with a PDA that is connected via wireless LAN with high data bandwidths and with no common carrier access charges when the PDA is within range of the access points providing connectivity between the PDA and the LAN hosting the system.

CDPD or Cellular can be utilized over a much larger geographic area because of the widespread installation of infrastructure to support this kind of network. The wide area of this service is a plus, however this service is often billed based on “air time” or packets sent, and the cost of using the system to deliver imagery and video can be very high due to the large amounts of data utilized.

An important feature of the invention is the provision for multiple methods of connectivity of PDA's to the hosting network as follows:

1) Plug-in Connections for areas where absolute connectivity is needed, such as a particular monitor desk or station for a guard.

2) Wireless LAN connectivity for completely mobile connectivity in areas covered by WLAN access points, and

3) Wireless Carrier connectivity for areas not covered by WLAN access points, such as outdoors on in patrol cars.

The host software on the PDA selects the appropriate carrier for the situation. For example, in priority order, if a wired connection is available, use it. If not, if a WLAN connection is available, use it. If not, if a W-WAN connection such as CDPD is available, use it. If not, and if a more costly W-WAN connection is available, such as cellular, use it.

Also, the “trigger” that initiates notification can be from video motion detection, video object appearance/disappearance detection, or other triggers, such as infrared motion detection, acoustic detection, contacts, and the like.

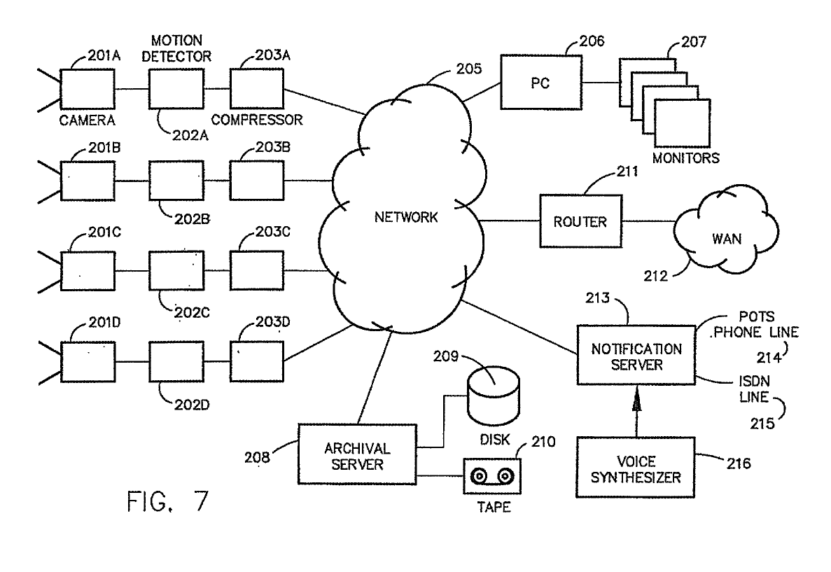

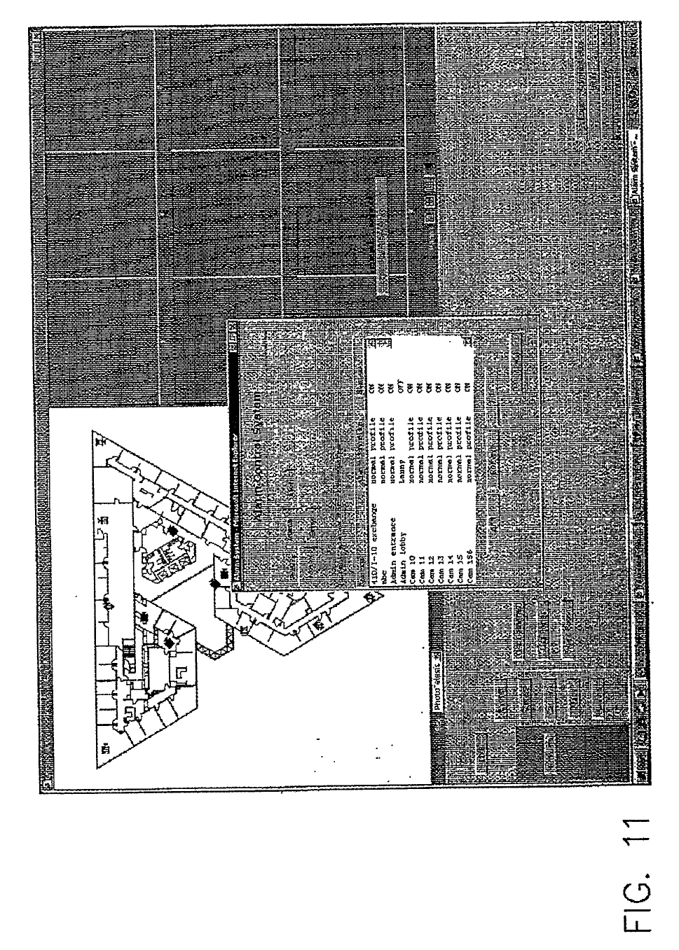

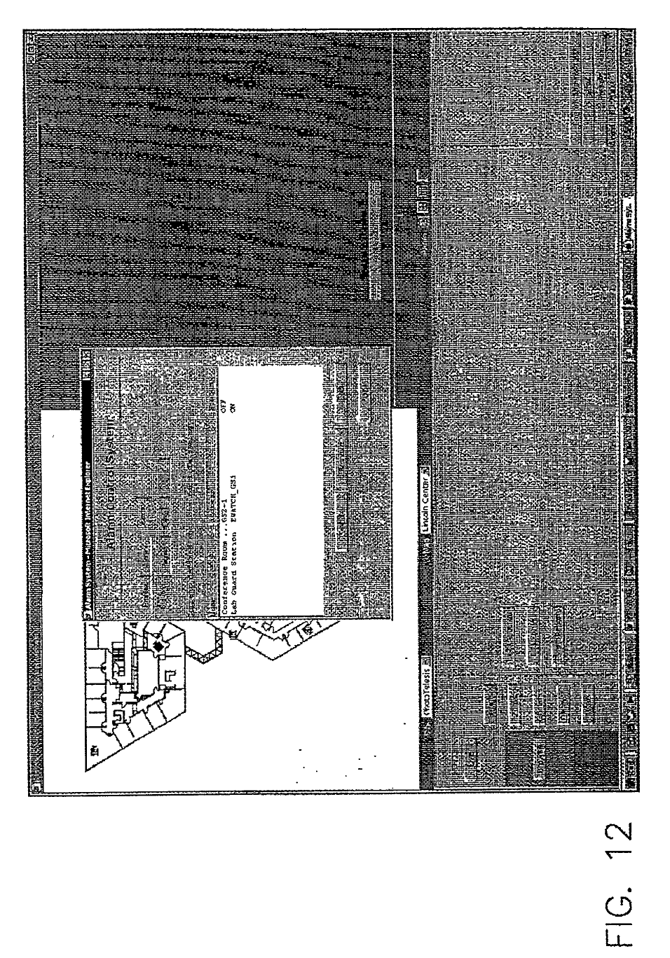

An exemplary embodiment of a system enhanced to selectively notify designated personnel upon detection of a motion event, or any other event detectable by the system is shown in FIGS. 7-23. The notification takes a variety of forms, including:

Placing a call to a common pager, and passing to the pager information descriptive of the event.

Placing a call to a designated telephone number, and describing the event using a synthesized voice. Note that the telephone may be a mobile phone.

Sending an e-mail message to designated recipients, wherein the body of the e-mail contains information descriptive of the event. Note that the e-mail may be conveyed by any suitable network, including LAN's, WAN's, or wireless networks.

A ‘pop-up’ notification on a system operator's console. The ‘pop-up’ message may be supplemented with a display of the live scene wherein motion was detected. Again, note that the operator's station may be connected by any suitable networking infrastructure, including LAN, WAN, or a wireless network.

In FIG. 7 the cameras 201A through 201N are disposed around a facility, capturing scenes of interest. Each camera contains a video motion detector 202A through 202N. Detection of motion within a video scene can be accomplished through a variety of means, as described in a previous disclosure. Typically, the motion detection algorithm looks for pixel value variations between captured scenes. Subsequent image processing may be used to yield further information concerning location of the motion, or the amount or direction of the motion. Such image processing may also suppress unimportant pixel changes due to camera noise or diurnal changes in natural lighting.

The camera's video signal is then optionally compressed in compressors 203A through 203N. A variety of digital video compression schemes are in common usage. The compressed video is then conveyed via network 205 to a monitor station 206, or to an archive server 208 for image storage on disk 209 or tape 210. Note that the network may support a number of monitor stations 206, as needed.

Due to the large bandwidth of a streaming video signal, it is often undesirable for the archival server 8 to store all of the video, or even the still images, captured by the plurality of cameras. These storage requirements may be reduced by capturing only those scenes, which contain motion. To accomplish this, the various cameras may be programmed to transmit to the network only those video scenes, or still images, which contain motion of interest.

The utility of the system as a security and surveillance system may be greatly enhanced if the system is able to notify appropriate security personnel when motion of interest is detected. To accomplish this, a notification server 213 is added to the network as depicted in Fig. 7. Note that the notification server 213 need not necessarily be a separate physical device; it may take the form of a task running on an existing network resource such as the PC 206 or the archival server 208.

The notification server 213 receives messages generated by any camera 201A through 201N, which has detected motion. Upon receipt of the message, the notification server consults an internal table containing notification instructions. This internal table is created and maintained by the system administrator. The table defines the communications resources available to the notification server, including the telephone line 214, ISDN line 215, or network router 211 which in turn provides a communications path to an external network 212. The table also includes information which:

identifies the correct person to notify when motion is detected,

describes the proper method to be used, and

describes daily intervals during which personnel are to be notified.

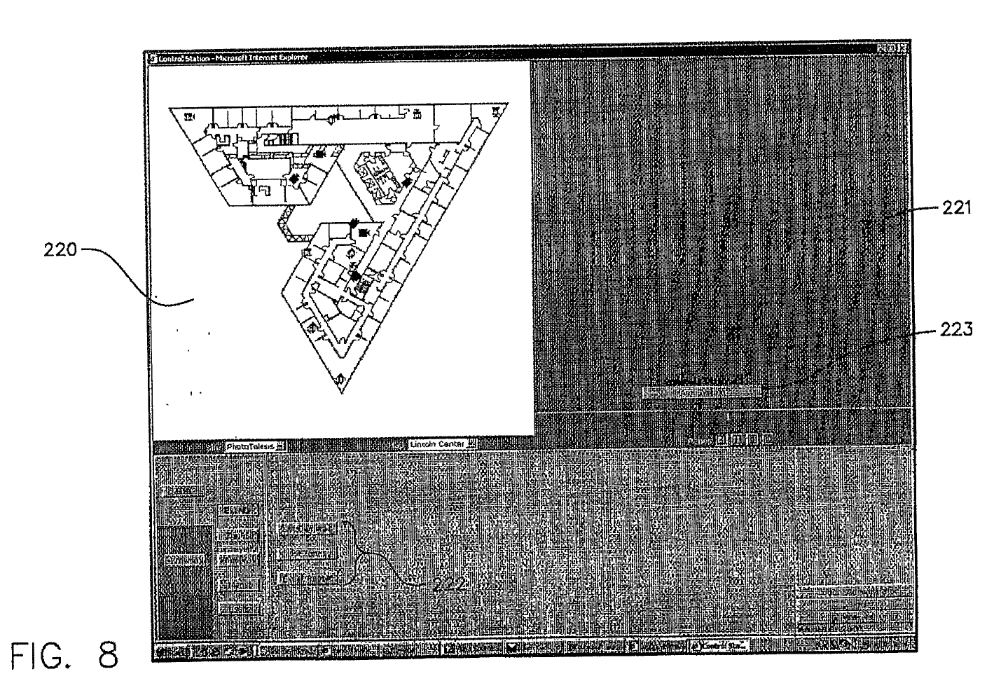

FIG. 8 depicts the main user screen. The screen contains a map 220 of the facility, depicting the location of the various cameras. Area 221 displays one or more live video scenes from the various cameras. A series of buttons 222 provides a means for the user to control and configure the system. Button 223 allows the user to arm or disarm the alarm functions of the system.

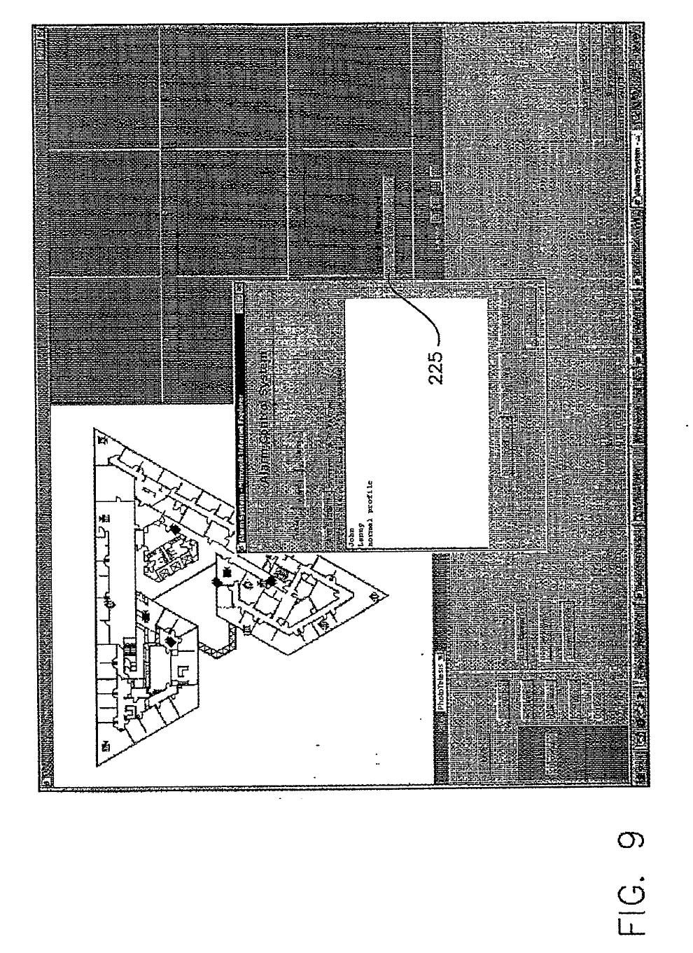

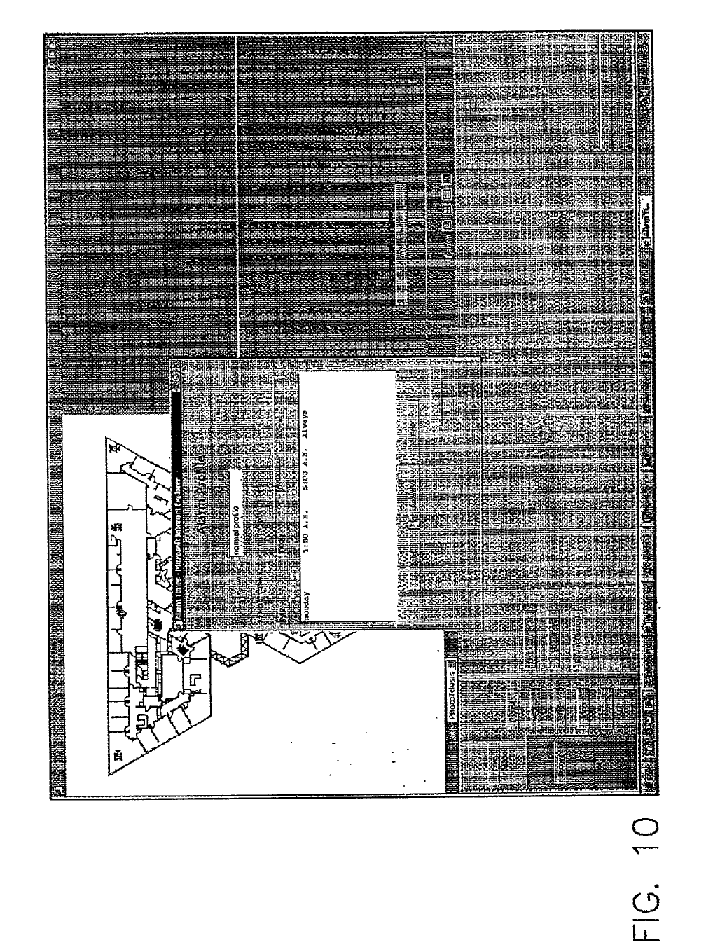

When the user selects the EVENTS button, the system displays a box that allows the user to configure the various event notification functions. This control box is illustrated in FIG. 9. As shown, the alarm control Panel provides three selection tabs: Profiles, Alarms, and Alerts. In FIG. 9, the Profiles tab has been selected. The system displays the current alarm profiles for which the system has been configured, and provides options for the user to Edit the existing profile, Remove it, or Add a new profile. Button 225 allows the user to arm or disarm the alarm functions of the system.

In FIG. 10, the ‘Normal Profile’ entry has been selected, and the ‘Edit’ button has been pressed. The dialog box displays the current settings for the ‘Normal Profile’. In this example, the ‘Normal Profile’ has been configured to arm the system between the hours of 1:00 AM and 5:00 AM every Monday.

In FIG. 17, the ‘Alarms’ tab of FIG. 9 has been selected. The dialog box displays two additional tabs: ‘Motio’ and ‘Entry’. In FIG. 17, the ‘Motion’ tab has been selected. This dialog box controls which cameras may be used to detect motion and generate alarms. An additional tab, labeled ‘Entry’, allows the user to configure other security sensors such as door entry switches as sources of alarms.

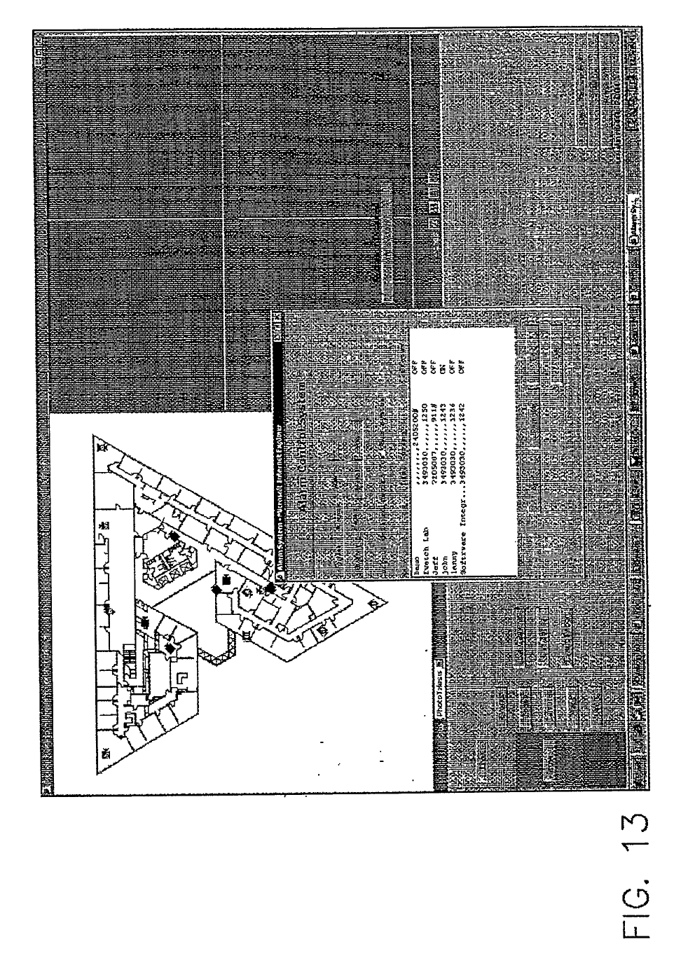

In FIG. 12, the ‘Stations’ tab has been pressed. The resulting dialog box allows the user to define which monitoring stations will display a ‘pop-up’ image of video from a camera, which has detected motion.

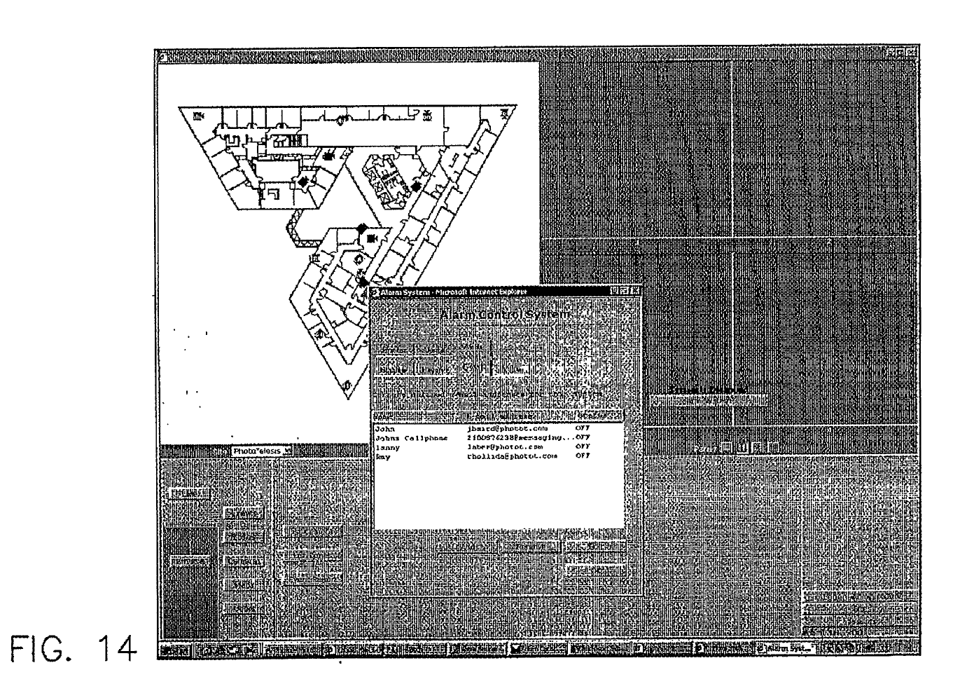

In FIG. 13, the ‘Pagers’ tab has been selected. The resulting dialog box displays a list of telephone numbers for common pagers, and allows the user to configure which pager will be alerted when an alarm condition is detected.

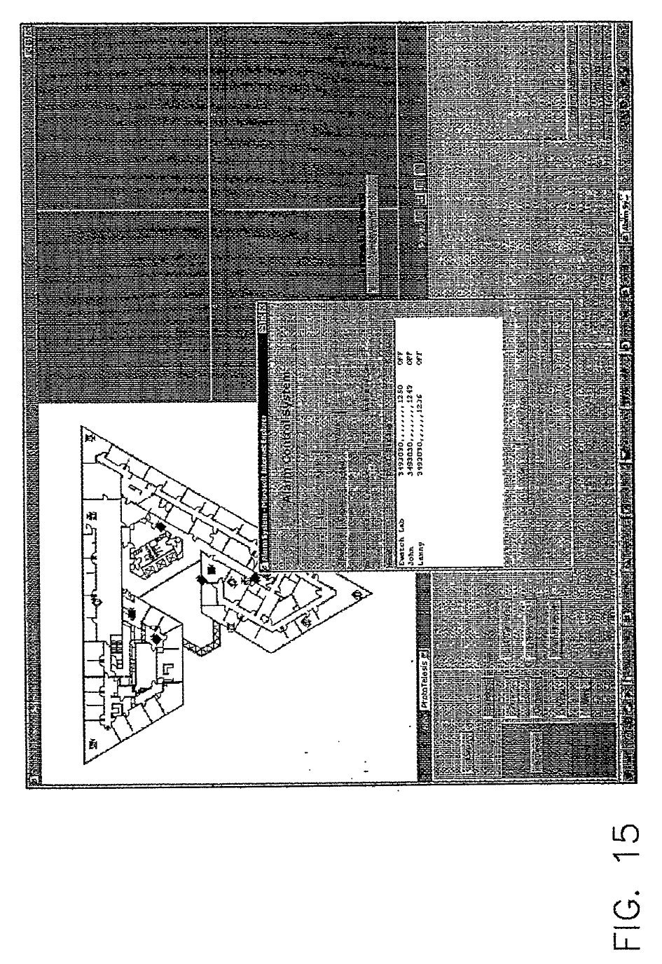

In FIG. 14, the ‘E-Mail’ tab has been pressed. The resulting dialog box displays a list of names and corresponding E-Mail addresses. Using this dialog box, the user may configure the system to send an E-Mail to a selected address when an alarm is detected.

In FIG. 15, the ‘Voice’ tab has been pressed. The resulting dialog box displays a list of names and dialing instructions to the system. Using this dialog box, the system may be configured to dial a defined telephone number and play back a pre-recorded voice announcement, describing the alarm. As an alternative to pre-recorded voice announcements, the system may synthesize speech using any of a variety of common voice-synthesis methods. Wireless?

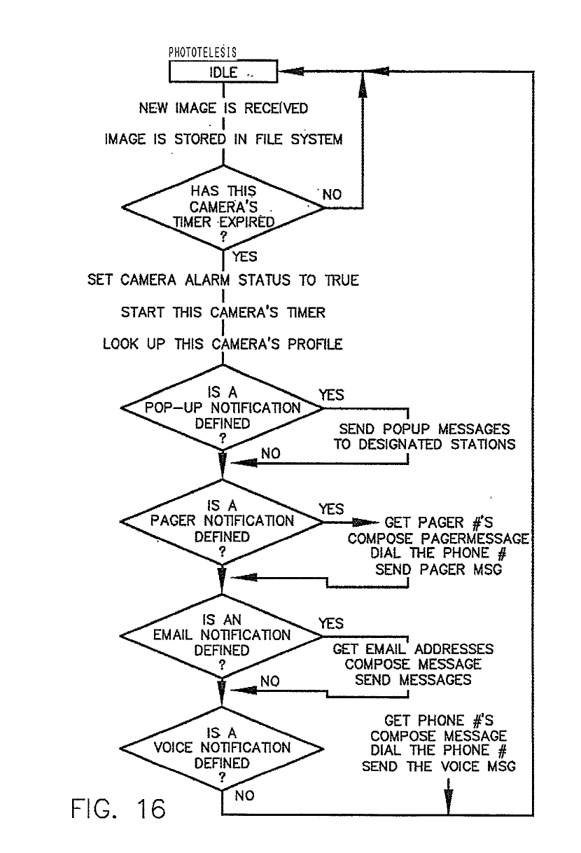

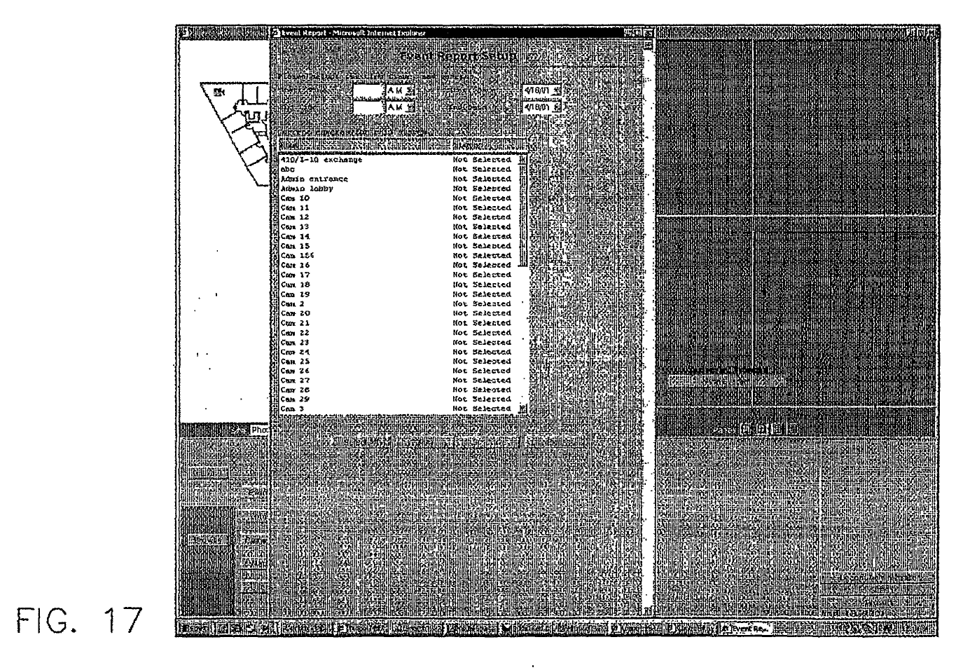

FIG. 16 illustrates a flowchart of the Event Notification system, which executes on a network server. When the server receives a still-frame image from a camera as a result of motion detection, the server stores the image on a local disk drive. Additionally, the server checks to see if that camera's timeout timer has expired.

If the camera's timeout timer has not expired, then no further action is taken. If, however, that camera's timer has expired, then the receipt of this new image is interpreted as a new motion event. The system sets that camera's alarm condition and restarts the camera's timer. The timer typically has a value of 1 to 10 minutes. It prevents repetitive motion-generated images from being interpreted as separate motion events. It also reduces the annoyance of a camera producing another alarm immediately after the previous alarm has been cleared.

The system then looks up the alarmed camera's entry in the notification table, determines what sort of notification is appropriate, and sends the appropriate notification.

### EVENT REPORTING

The archive server stores images or video streams from the networked cameras. Since digitized images and especially video streams tend to be very large, the images or video are suitably compressed prior to storage. Furthermore, to conserve storage space, the server may be configured to store only those images or video streams that contain a motion event, or other event of interest.

As previously disclosed, the server ‘tags’ it's still-frame images with information indicative of which camera captured the image, and of the time and date of the image. This supports efficient retrieval of desired images based on simple inquiries describing location and time of the images. Additionally, the server may store related information concerning the images, such as location or amount of motion within each captured scene, or other alarm that may have triggered the image such as door entry switches, fire detectors and the like.

In the present invention, the server is enhanced to generate reports indicative of motion patterns for any given camera or group of cameras. For instance, a camera disposed at the main entrance of a building may show a greater degree or frequency of motion at 8:00AM and 5:00 PM, may show moderate or occasional motion between those hours during the day, and show zero motion overnight. Such information is of value to security personnel, as it enables them to identify activity patterns or trends in patterns over time.

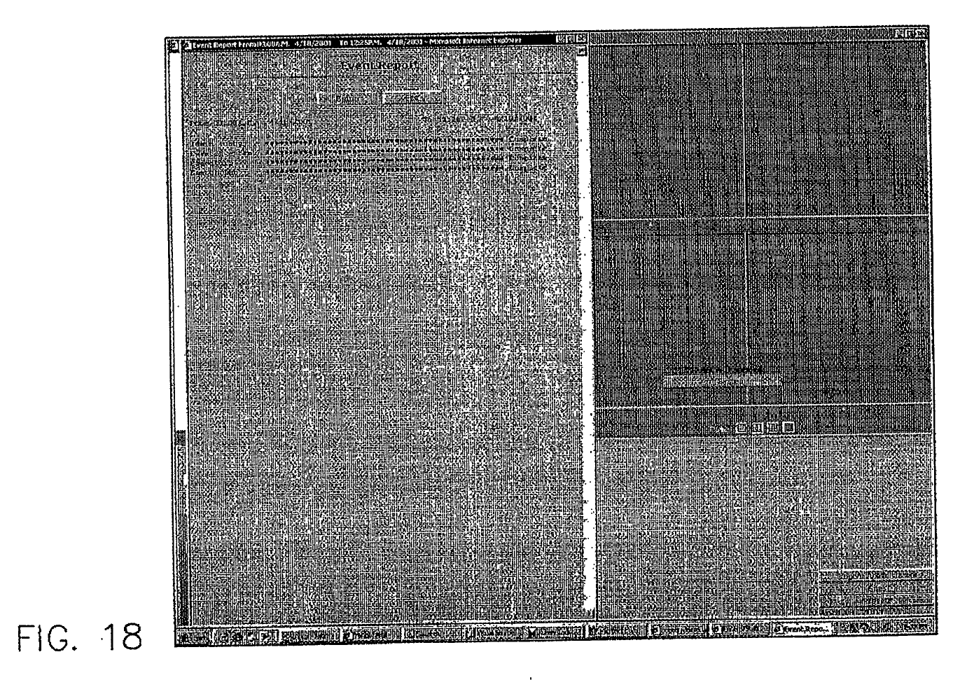

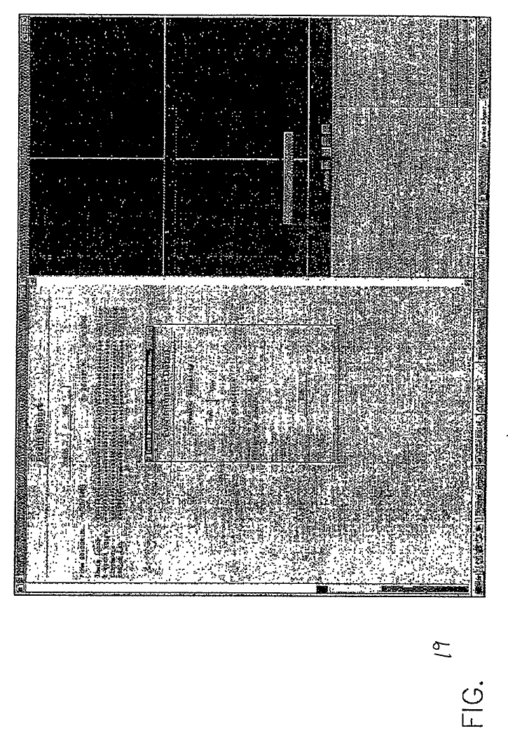

FIGS. 17 through 22 depict an embodiment of such an Event Reporting system, as seen from a user's point of view. In FIG. 17, the ‘Event Report’ tab of FIG. 8 has been pressed. To request an alarm report, the user enters information describing the time, date, and location of the desired camera(s). After the ‘Run’ button is pressed, the Event Report of FIG. 18 is displayed. In FIG. 18, each camera is represented by a horizontal row of colored dots. Each dot represents a scaled interval of time within the range previously specified by the user. The color of each dot represents the number of motion events that occurred during that time interval.

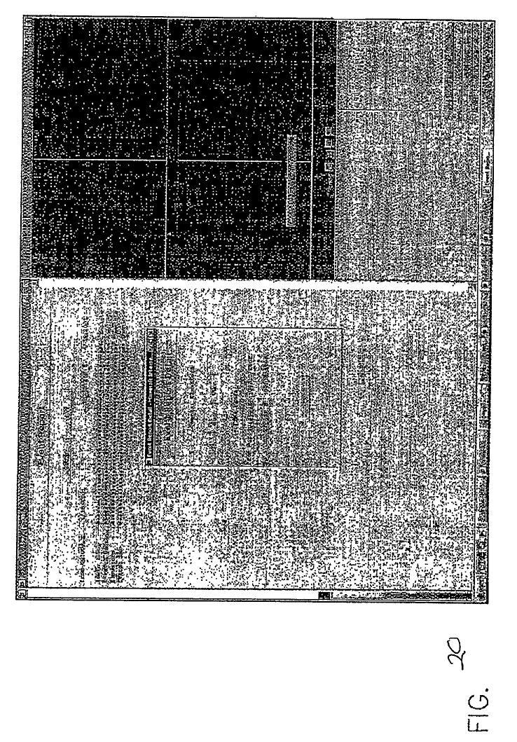

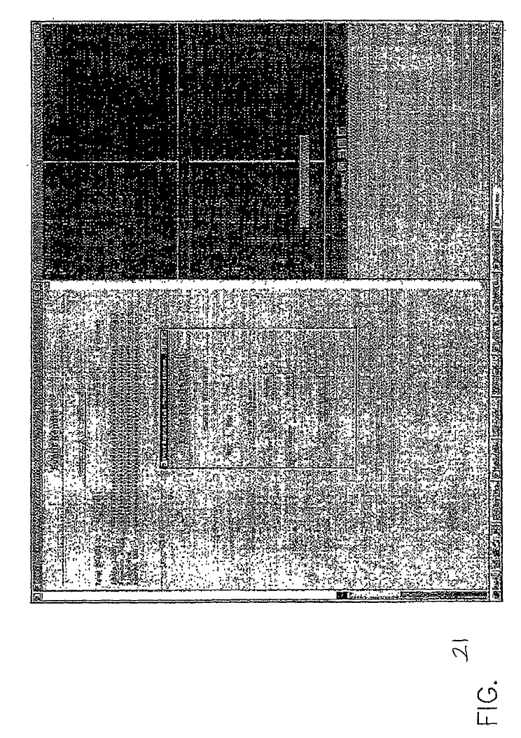

When the user places the mouse cursor over any dot, a bubble appears describing the time interval selected by that dot. If the user then clicks on the selected dot, the screen of FIG. 19 is displayed. When the ‘Stats’ tab in FIG. 19 is clicked, the system displays information describing the number of images in the database covering the selected camera over the selected time span. When the ‘Time’ button if FIG. 19 is pressed, the system displays the screen of FIG. 20. This displays the time interval selected by the user.

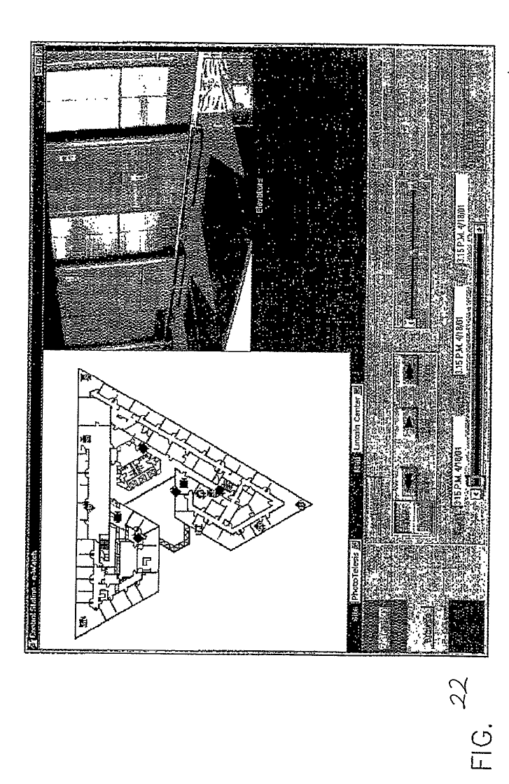

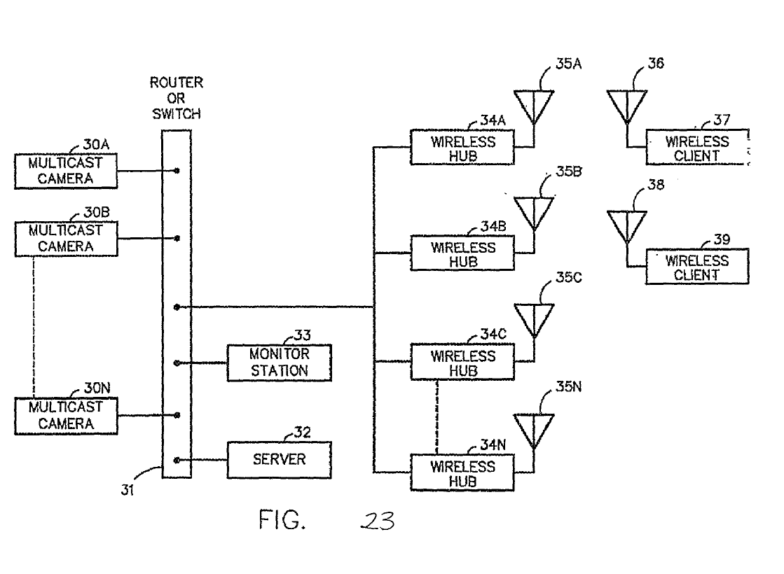

Finally, when the ‘View’ tab of FIG. 19 is pressed, the screen of FIG. 21 is displayed. The user may view the actual images captured by the system by pressing the ‘Images button’. FIG. 22 is a representative image thus displayed.

### NOTIFICATION ALARM FEATURE

The system of the subject invention is a sophisticated situational awareness system that is network based. The elements of the system include digital surveillance information collection, information processing system, automated dispatch, logging, remote access and logging. The system consists of intelligent sensors, servers, and monitor stations all interconnected by wired and wireless network connections over potentially wide geographic areas.

The traditional information that is collected, analyzed, archived and distributed is raw sensor data such as images, video, audio, temperature, contact closure and the like. This information has been traditionally collected by legacy closed circuit television systems and alarm systems. The system digitizes all of this information and distributes it to the monitor stations and to the notification processor 106 (FIG. 6) for analysis. The processor 106 analyzes the information and dispatches security and/or administrative personnel based upon events such as motion detection or a triggered sensor in a particular area in a particular time window when the system is “armed”.

A fire alarm is another example of a traditional event that is processed by the system. In this case a smoke or temperature sensor detects fire in a traditional manner, or a “Fire” pull handle is pulled, and the appropriate personnel can be dispatched, including the fire department.

A medical alarm is a third example of a traditional event that is processed by the system. Other classes of events, which are not traditionally handled by “conventional” video surveillance, fire alarm, medical alarm, and security systems are readily handled by the system. Examples are:

Administrative Events: The intelligent cameras not only detect motion, but they can detect levels of activity or appearance or disappearance of objects. These events are not necessarily classed as a Security Alarm whereby security personnel are dispatched, but may be informational events for administrative personnel. Other system support information, such as the need to change tapes in a storage array, is also administrative in nature. These alarms can be selectively sent to the appropriate personnel. Another example of an administrative event would be a low battery alarm on a portable wireless surveillance camera. This would call an administrator to recharge the camera or change the battery.

Maintenance Events: All of the system components are digital and networked together. Because of this, the health of the components can be monitored. For example, a battery of digital video surveillance cameras can be monitored for health. This can be done by the camera transmitting an “I am alive and well” signal to a monitor process, or by a monitor process polling the appliance to ask it is “alive and well”. If one or more of the cameras fails to transmit or respond an “all is well” signal, alarms can be generated to call for maintenance. Other alarms can be dispatched as well. For example, a security guard can be dispatched to the appliance area to confirm that the appliance has not been vandalized.

Appliance and camera outages may be detected by several means or occurrences such as, by way of example, a lack of a heartbeat or pulse from a specific appliance or a lack of a response in the event of polling the appliance. It is desirable to run a periodic appliance system check in order to determine an internal failure. This may be a low-power condition or an over-temperature condition. This would trigger a maintenance alarm condition in the form of an error code.

In the case of video cameras, an all white or all black image would also indicate malfunction, as would a noticeable change in the histogram for the camera scene. This, for example, would indicate covering the lens as well as a camera malfunction.

The processor can analyze all types of events and perform dispatch to combinations of organizations and personnel that are tailored to the event. For example, a matrix can be set up of events and personnel. A typical notification table follows:

| | NOTIFIED AUTHORITY | | | | | | | |
|---|---|---|---|---|---|---|---|---|
| SENSOR | Admin. | Fire Dept. | EMS | On-Site | Police | LAN | Nurse | Security |
| Intrusion | X | | | X | X | | | X |
| Video Motion | X | | | X | | | | X |
| Acoustic Event | X | | | X | | | | X |
| Fire Sensors | X | X | X | X | | X | X | X |
| Health Pull Bar | | | X | X | | | X | |
| Motion Level | | | | X | | | | X |
| OPERATIONAL ALARMS | | | | | | | | |
| (Battery, Tape, etc.) | X | | | X | | | | |
| Appliance Failure | X | | | X | | | | |
| Server Failure | X | | | X | | | | X |

It should be readily understood that any number of events can be defined, as well as any number of response parties can be identified. The exact configuration of the notification tables is user configurable.

There are other dimensions to the above matrix. For example, time may be used to qualify response. Specifically, the on-site administrator may be notified during operating hours, and the police notified after hours. The on-premises nurse may be notified during operating hours and EMS notified after hours. Also, administrators or security personnel may be selected to respond based upon geographic location of the event relative to the geographic location of the response person/unit. This can be done by assigned areas, or by utilization of electronic geo-location of the responding personnel or vehicles.

When a maintenance event is detected, the decision server selects the specified person to be notified and attempts notification per the already defined methods: dial up telephone, dial up pager, dial up wireless telephone, digital pager, digital telephone, digital PDA device, e-mail to pager, e-mail to digital telephone, e-mail to wireless PDA devices, e-mail to a computer, or any combination of these devices.

TEXT devices can have a detailed description of the problem, such as the type of problem, appliance or server location, time of failure, extent of failure, etc.

AUDIO devices, such as a telephone or voice pager, either audio describing the event can be played, such as from a wave file, or voice synthesis audio can be presented to the user. Tree structure notification tables as previously discussed can be utilized, and confirmation of event by the notified party can be implemented as previously discussed.

The notification operations can be initiated by an automatic “trigger” such as, by way of example, the detection and transmission of video motion, object appearance/disappearance or other events, including acoustic detection, the opening or closing of contacts and the like.

Alarm systems can be set by zones, with master zones including some or all other zones. The activation of the notification sequence can be programmed, include specific terminals, or can be dial in with a pass code. Each zone may have a table of authorized users with the authority to activate and deactivate the relevant zone by dial in, console and user interface point-and-click technology as described later herein. The activation and deactivation activities are logged on the system server, with user, time and method of access monitored and logged. Each zone includes a notification table consisting of one or more lists having an established priority. The notification sequence will begin with the highest priority and continue down the list until a confirmation of receipt is logged. It is possible that more than one entity on the list will have the same priority. For example, a medical emergency might include both an on-site nurse and an administrator as the same priority or as different priorities. The zone table will also include a plurality of methods of notification including telephonic, paging, e-mail or pop-up window on system terminals. The methods are also prioritized and will continue sequencing until confirmation is received.

In one aspect of the invention the alarm condition will be indicated directly on the on-screen system map. This will show as a flashing icon at the point of the event, with the icon identifying the type of event. For example, a fire icon will indicate a fire alarm, a gun icon could indicate a loud, short acoustic event, as so on. An audible alarm may be generated at the same time, alerting personnel to check the map for an event.

The pop-up window will also be utilized in connection with the on-screen monitoring functions and automatically pop-up at selected stations in the event of a triggering event occurrence. Again, the pop-up feature will be controlled by the server to select where the signal is sent, with password protection for indication of receipt, and logging of activation and deactivation activity.

Telephonic notification will send a signal out over land lines and/or wireless lines in accordance with the established hierarchy. Notification is in most case via speech synthesis or taped messages indicating type and location of event, with receipt being controlled by password protected responses. Pagers can be used in a similar fashion.

It is an important aspect of the invention that e-mail notification is incorporated in the notification operations. This includes both e-mail paging and traditional e-mail, with the location, time and type of event being forwarded in the message. Receipt acknowledgement is password protected and is logged as previously discussed.

### USER INTERFACE

A Graphical User Interface (GUI) is provided to allow a user to search or browse images in the database. The GUI also allows the user to perform automated searches through the Archive for events of interest.

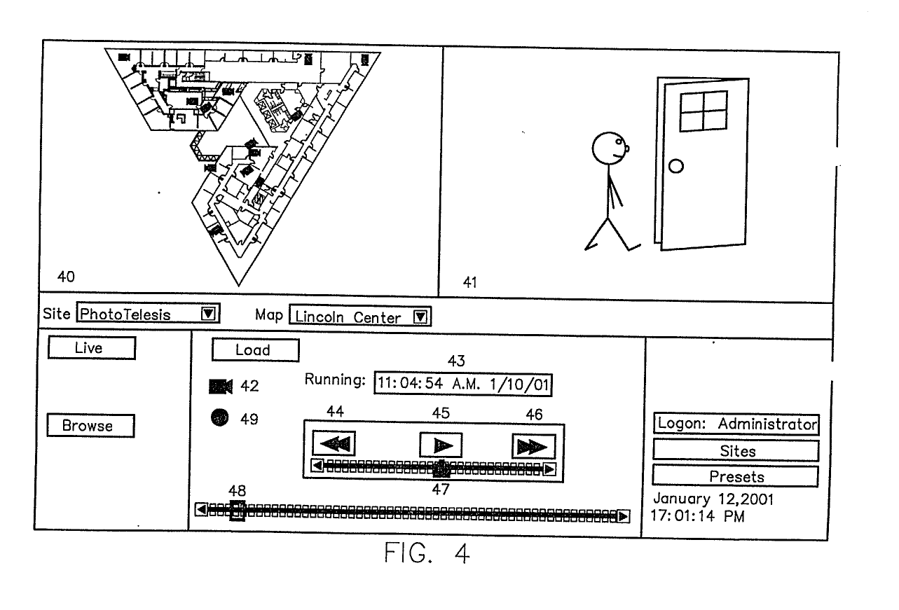

The basic GUI is depicted in FIG. 4. The upper left region contains a map 40 of the area covered by the system. Thee upper right region contains the image 41 currently retrieved from the Archive Server. The bottom of the screen contains a series of controls used for image searching and browsing. When viewing archived images, an indicator 43 shows the time and date of the image currently displayed. A play button 45 causes stored images from the current camera to be displayed sequentially, at a rate controlled by the speed slider control 47. The pair of buttons 44 and 46 are provided to allow the user to manually step backwards or forwards respectively. A slide indicator 48 is provided to indicate the position of the current image within the selected time interval, and to allow the user to zoom forwards or backwards by dragging the indicator. Finally, a Button 42 may be clicked to indicate which camera is currently displayed, and button 49 may be clicked to indicate the current time span available for display.

In a refinement, the camera icon, located in the map screen, which represents the currently viewed camera, may be made to flash or blink to indicate to the user which camera he is viewing. In addition, the blink rate of the icon may be varied to represent the degree of motion in the current scenes, as indicated by the motion histogram data associated with the image. Alternatively, the camera icon may be annotated with a symbol or number to represent the degree of motion in the current scene.

Note that this ‘amount of motion’ indication may be used either for still images being viewed from the server's archive, or for live video currently being generated by the various cameras. When used with archived still images, all camera icons on the map may be used to indicate the degree of motion detected by the represented camera at the currently viewed time. When the system is used for viewing live video scenes, all the camera icons on the map may blink at a rate indicative of the motion detected by each camera at the present time. When used with live cameras, the detection of motion may cause the user's video display screen to switch to the camera or cameras that detected motion. Moreover, the user's screen may highlight the regions of the scene where motion was detected, either by enhancing the brightness and contrast of the motion zones, or by outlining the motion regions.

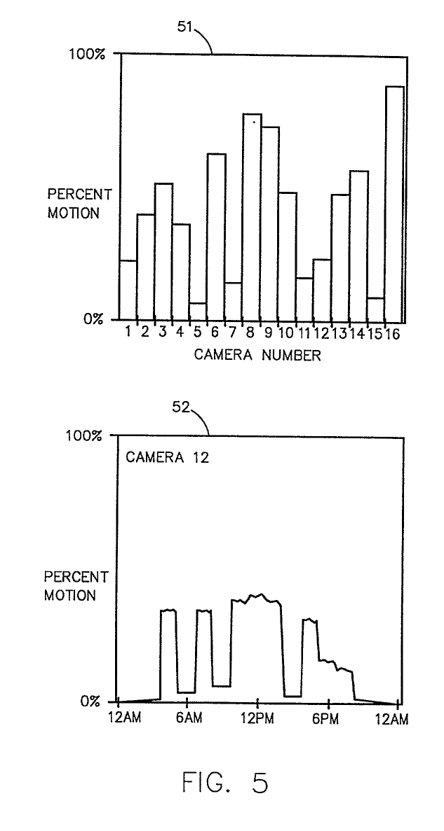

Each camera's motion detection algorithm is continually active, and each camera transmits to the server data describing all non-zero motion in its field of view. Accordingly, additional refinements are possible. In FIG. 5, a new item is added to the GUI, a histogram bar chart 51. This bar chart 51 is organized to list camera number on the X-axis, and amount of motion detected along the Y-axis. This, combined with the flashing camera icons in the map area, gives a user an immediate and quantitative description of areas of motion throughout the facility when applied to live video.

The histogram bar chart 51 may also be used when viewing archived images. Since all detected motion data is stored on the server, the GUI can present to the user facility-wide histogram bar chart summarizing all motion in the facility at the time of the currently viewed image. An array of video motion detectors may be used to drive the histogram chart. One screen then shows the entire level of motion in all cameras in, for example, a school. This could look somewhat like a big audio spectrum VU meter display, but instead of frequency bands it would be specific cameras. It could be configured, for example, such that the level of motion would drive the histogram display higher.

As the images are played back by the user, the respective motion histogram is played back as well. This allows the user to view motion patterns. This playback may be either forward or backward, and may be played faster or slower than the original capture speed. During playback, motion events or other system alarm conditions (such as door alarms, etc) may be indicated by flashing icons or sprites on the map screen, or by highlighted areas in the respective image.

In a further refinement, any selected camera's historical motion data may be graphically summarized, as depicted in FIG. 5 item 52. This chart indicates the amount of motion detected by a selected camera vs. time. In the example, camera 12 has been selected and its captured motion data is plotted versus time-of-day. The plot shows long overnight periods of inactivity, followed by periodic intervals of motion during the day. Such historical data may be used to derive daily motion cycles for any given camera. The server may use this ‘motion pattern history’ as a basis for generating an alarm whenever motion occurs at time outside the usual pattern.

As previously discussed, the camera produces a matrix of regional motion histograms, which quantify motion in different areas of the scene. The motion detection algorithm provides a means for selective masking particular areas of interest or disinterest within the scene. The GUI provides a convenient way for a user to select areas to mask or unmask. In FIG. 3, scene 33 contains an object 37 that the user wishes to mask. Using the GUI, the user selects the desired regions by either clicking the mask on the desired cells, or by using the mouse to draw a line surrounding the desired cells. Once selected, the user may then enter a weighting value from zero to one for the selected cells. The assigned values are then placed in the weighting matrix 35 in Fig. 3, and used in the motion detection algorithm previously described.

Motion detection, as previously described, may be used to automatically switch the user's monitor screen to a real-time view of the live video from the camera with motion. Further, since the user's monitor screen may display more than one camera in a split-screen or matrix, it is possible for multiple cameras, each detecting motion, to automatically appear on the user's monitor. Alternatively, the user's split-screen may be used to display a motion sequence from one particular camera that has detected motion. If multiple cameras detect motion sequentially, such as when an intruder walks through a building, the user's monitor screen may display the motion sequence as the activity proceeds from one camera to the next.

Moreover, the map display may be overlaid with vectors, showing the intruder's movements schematically through the building. In a refinement, these movement vectors on the map may be rendered more accurate by knowledge of which regions within a scene-contained motion. For example, if a gymnasium camera was configured for a wide shot, it might show three sides of the gymnasium and several doors. If motion is detected only at door 3, then the movement vector on the map display so indicates.

For event reconstruction, it is useful to play back multiple image sources, synchronized with each other and with their respective motion data. Since the GUI supports multiple-screen displays, and also supports multiple-images per monitor, it is possible to playback multiple cameras from the stored image database. These synchronized multiple images and their respective map icons and motion data, may be played backwards or forwards, may be paused, and may be played at various speeds while all maintaining synchronization with each other. Any other associated data in the server's database, such as motion detection, security alarms, door or window contact switches, fire detectors, lighting controls, etc, may be played back in synchronism with the images.

In addition to the playback of one image using either still or video data, it should be recognized that the system is capable of playing back multiple image/video sources at the same time using the multiple screen capability. This allows, for example, selection of cameras to review then playing back all of the cameras in a synchronized fashion, forward, reverse, fast, slow, and so forth. All panes would be updated as the database is “jogged and shuttled” around. All icons on the map would also respond as the database is being “jogged and shuttled”. It should also be noted that playback of a database may include playback of all detected events, not just images. For example, non-video motion detectors, door contacts, light controls, and the like that are recorded in the database can be displayed as the database time is “jogged and shuttled”.

The creation of logical ‘zones’ increases the utility of the system. For example, in a museum, an overhead camera may have a scene of a valuable painting. Regions of the scene containing the painting may be assigned to the ‘painting zone’, while areas of the scene containing visitors may be assigned to the ‘visitor zone’. To ease system operation, the ‘painting zone’ may have motion detection enabled all of the time, while the ‘visitors zone’ may have motion detection disabled during the day.

FIG. 23 illustrates a plurality of cameras, 30A-30N, attached to a router or switch 31. Router 31 may be attached to a monitor station 33, a server 32 and/or a plurality of wireless hubs 34A-34N. In addition, router 31 may be in communication with wireless client devices 37, 39.

While certain embodiments and features of the invention have been described in detail herein, it will be readily understood that the invention includes all modifications and enhancements within the scope and spirit of the following claims.

1. A method for collecting, selecting and transmitting selected data available at remote location to selected stations on a network, comprising the steps of:
a. collecting data based on a event occurring at the remote location;
b. prioritizing the data and generating a prioritized signal from the prioritized data;
c. transmitting the prioritized signal to a receiving station located on a network based on the priority; and
d. managing the transmitted prioritized signal at the receiving station.

2. The method of claim 1, further including in the prioritizing step the time and location of the event in the transmitted prioritized signal.

3. The method of claim 2, wherein the collected data includes an image signal and wherein the transmitted prioritized signal includes an image component.

4. The method of claim 3, wherein the collected data defines an original scene and wherein the transmitted data is generated in response to a modification of the original scene, the method further comprising:
a. collecting the data on a preselected basis;
b. defining and transmitting an original scene to the remote station;
c. comparing subsequent scenes to the original scene;
d. transmitting only those subsequent scenes differing from the original scene.

5. The method of claim 4, wherein the comparing step is completed at the camera.

6. The method of claim 5, wherein the data is in the form of digital pixels and wherein the comparing step comprises identifying only those pixels altered from the original scene.

7. The method of claim 6, further comprising the step of generating a change histogram from the change information created in the comparing step.

8. The method of claim 4, further comprising the step of masking specific regions of the scene in order to ignore changes in said region.

9. The method of claim 4, further including the step of tagging each transmitted image with unique identifying data.

10. The method of claim 9, wherein the tagging step is performed at the remote location.

11. The method of claim 9, wherein the identifying data includes the date and time of the data defining a scene.

12. The method of claim 9, further wherein the identifying data further includes the duration of the data defining a scene.

13. The method of claim 11, further including a plurality of cameras and wherein the identifying data further includes a camera identifier.

14. The method of claim 4, further including a visual monitor at the remote location, wherein transmitted data may be selectively displayed at the monitor.

15. The method of claim 14, wherein transmitted data is displayed at the monitor in near real-time.

16. The method of claim 14, further including the step of tagging each transmitted image with unique identifying data.

17. The method of claim 16, wherein the unique identifying data is displayed with the displayed data.

18. The method of claim 17, wherein the monitor further includes a map of the scene.

19. The method of claim 18, further including a plurality of cameras and wherein an icon representing each camera is provided on the map.

20. The method of claim 19, further including an indicator that is activated when the data from a specific camera is displayed on the monitor and deactivated at other times.

21. The method of claim 4, further comprising the step of storing the transmitted data at the remote location.

22. The method of claim 21, further including the step of retrieving the data from the stored data on command.

23. The method of claim 22, further including the step of tagging each transmitted image with unique identifying data.

24. The method of claim 23, wherein the tagging step is performed at the remote location.

25. The method of claim 23, wherein the identifying data includes the date and time of the data defining a scene.

26. The method of claim 25, further wherein the identifying data further includes the duration of the data defining a scene.

27. The method of claim 25, further including a plurality of cameras and wherein the identifying data further includes a camera identifier.

28. The method of claim 1, wherein the managing step comprises generating an alarm at the receiving station.

29. The method of claim 1, wherein the managing step comprises displaying the transmitted signal at the receiving station.

30. The method of claim 1, wherein the managing step comprises generating an alarm and displaying the transmitted signal at the receiving station.

31. The method of claim 1, wherein the managing step comprises storing the transmitted signal at the receiving station.

32. A method for collecting, selecting and transmitting selected event data available at a remote location, comprising the steps of:
a. collecting data on a preselected basis;
b. defining and transmitting original event data to the remote location;
c. comparing subsequent event data to baseline data;
d. transmitting only event data differing from the baseline data;
e. tagging each transmitted event data signal with unique identifying data; and
f. storing the transmitted event data at the remote location.

33. The method of claim 32, further including the step of retrieving the event data from the stored event data on command.

34. The method of claim 32, wherein the tagging step is performed at the remote location.

35. The method of claim 32, wherein the identifying data includes the date and time of the corresponding scene data.

36. The method of claim 35, further wherein the identifying data further includes the duration of the corresponding event data.

37. The method of claim 32, further including a plurality of cameras and wherein the identifying data further includes a camera identifier.

38. The method of claim 1, further including a central management system and wherein the prioritizing step occurs after the collected data is sent to the management system.

39. The method of claim 38, further including retransmission of the data based on the prioritization of the data at the central management system.

40. The method of claim 39, wherein the retransmission step includes transmitting the data to selected recipients based on the prioritization step.

41. The method of claim 39, wherein the retransmission step includes generating a visual icon on a graphic display at a remote location.

42. The method of claim 39, wherein the retransmission step includes generating a voice signal at selected remote locations.

43. The method of claim 39, wherein the retransmission step includes a substep of defining a recipient hierarchy and retransmitting in sequence in accordance with the hierarchy.

44. The method of claim 43, further including the step providing a positive response signal to the central management system for indicating that a retransmitted signal has been received by a selected recipient.

45. The method of claim 44, further including the step of password encoding recipients.

46. The method of claim 44, further including the step of managing the system through the central management system by a selected recipient after a retransmitted message has been received.

47. The method of claim 1, wherein the prioritizing step occurs prior to the transmitting step.

48. The method of claim 1, wherein the prioritizing step occurs at a first hierarchy prior to the transmitting step and at a second hierarchy after the transmitting step.

49. The method of claim 1, further including the step of generating a notification signal in response to a transmitted prioritized signal.

50. The method of claim 49, wherein the notification signal is transmitted to selected recipients on a network.

51. The method of claim 50, wherein the notification signal is repeatedly transmitted until a selected recipient responds to the notification signal.

52. The method of claim 50, further including the step of assigning a prioritization hierarchy to a plurality of recipients and wherein the notification signal is transmitted to recipients based on this hierarchy.

53. The method of claim 49, wherein the notification signal is transmitted to monitoring stations on a network.

54. The method of claim 49, wherein the notification signal is transmitted via telephonic means.

55. The method of claim 49, wherein the notification signal is transmitted via e-mail.

56. The method of claim 55, wherein the e-mail further includes an attachment including additional, event specific data.

57. The method of claim 56, wherein the attachment is image data.

58. The method of claim 50, wherein the receipt and response to the notification signal is password protected.

59. The method of claim 3, including the steps of capturing an image of personnel attempting to gain access through an access control system and logging all successful entry attempts and all unsuccessful attempts.

60. The method of claim 21, including the step of searching the database by any combination of specific individual, class of individual, by successful accesses, by unsuccessful accesses, by specific portal of entry with qualifiers of time, day, and location.

61. The method of claim 60 including the step of providing an image of those personnel attempting access to a facility along with the results of a search of the database by any of a specific individual, class of individual, by successful accesses, by unsuccessful accesses, by specific portal of entry with qualifiers of time, day, location.

62. The method of claim 1, wherein the collecting step includes collecting event data at a remote location, identifying and prioritizing the data, and the transmitting step includes selectively transmitting the data to selective monitoring stations on a network based on an event prioritization hierarchy.

63. The method of claim 62, including the step of comparing data generated at a remote location to determine the occurrence of an event and the transmitting step further includes the data to a selective monitoring station indicating the occurrence of an event.

64. The method of claim 1, wherein the collecting step includes collecting video and still images of a scene and wherein the transmitting step includes transmitting any change in the scene in near real-time to a remote location.

65. The method of claim 1, further including the step of compressing the data prior to the transmitting step.

66. The method of claim 65, wherein the compressing step further includes minimizing the amount of data to be transmitted without any loss of critical change data.

67. The method of claim 1, further including the steps of defining the data in blocks of data and tagging each block of data with a unique identifier for enhancing storage, search and retrieval.

68. The method of claim 6, including the step of quantifying the amount of change between scenes.

69. The method of claim 6, including the steps of quantifying the amount of change between scenes and reporting such as an indication of level of motion.

70. The method of claim 6, including the step of ignoring anticipated or minimal changes in a scene by applying pre-selected criteria.

71. The method of claim 6, including the step of blocking of specified regions of a scene to further enhance the monitoring, transmission and definition of the changes in the scene of a frame-to-frame basis.

72. The method of claim 1, wherein the managing step further includes the step of correlating correlate motion between two or more cameras to determine if a motion detection event should be identified in order to eliminate false alarms.

73. The method of claim 1, further including the step of controlling all functions and steps from a single interactive monitor screen.

74. The method of claim 73, including the step of providing simultaneous access for two or more monitor screens each allowing functions of the system to be controlled by that interactive monitor.

75. The method of claim 6, including the step of detecting the appearance or disappearance of an object.

76. The method of claim 49, wherein the notification step includes detection of the presence of unauthorized events in a monitored zone and the transmitting step includes transmitting the detection to selected remote stations on a network on a near real-time basis.

77. The method of claim 49, wherein the notification step includes routing detected events, whereby the location of the incident may be visually located on a map at the remote station.
